(19) United States
(12) Patent Application Publication
(10) Pub. No.: US 2022/0067551 A1
(43) Pub. Date: Mar. 3, 2022

(54) NEXT ACTION RECOMMENDATION SYSTEM

(71) Applicant: Citrix Systems, Inc., Fort Lauderdale, FL (US)

(72) Inventors: Daowen Wei, Nanjing (CN); Jian Ding, Nanjing (CN); Hengbo Wang, Nanjing (CN)

(21) Appl. No.: 17/023,582

(22) Filed: Sep. 17, 2020

Related U.S. Application Data
(63) Continuation of application No. PCT/CN2020/113218, filed on Sep. 3, 2020.

(51) Int. Cl. G06N 5/04; H04L 29/08; G06F 3/0482; G06N 20/00

(52) U.S. Cl. CPC G06N 5/04; G06N 20/00; G06F 3/0482; H04L 67/025

(57) ABSTRACT

A computing system may determine that a user took a first action with respect to a first system of record after engaging in a first activity relating to a second system of record, determine that the first activity is of a first activity type, determine that the first action is of a first action type, and determine that the user has engaged in a second activity of the first activity type. Based at least in part on (A) the user having taken the first action after engaging in the first activity, (B) the first activity being of the first activity type, (C) the first action being of the first action type, and (D) the second activity being of the first activity type, a client device may be caused to present a first user interface element that is selectable to enable the user to take a second action of the first action type with respect to the second system of record.

### CROSS-REFERENCE TO RELATED APPLICATIONS

This application is a continuation of and claims the benefit under 35 U.S.C. § 120 and 35 U.S.C. § 365(c) to International Application PCT/CN2020/113218, entitled NEXT ACTION RECOMMENDATION SYSTEM, with an international filing date of Sep. 3, 2020, the entire contents of which are incorporated herein by reference for all purposes.

### BACKGROUND

Various systems have been developed that allow client devices to access applications and/or data files over a network. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method comprises determining, by a computing system, that a user took a first action with respect to a first system of record after engaging in a first activity relating to a second system of record; determining, by the computing system, that the first activity is of a first activity type; determining, by the computing system, that the first action is of a first action type; and determining, by the computing system, that the user has engaged in a second activity of the first activity type. Based at least in part on (A) the user having taken the first action after engaging in the first activity, (B) the first activity being of the first activity type, (C) the first action being of the first action type, and (D) the second activity being of the first activity type, a client device is cause to present a first user interface element that is selectable to enable the user to take a second action of the first action type with respect to the second system of record.

In some embodiments, a system comprises at least one processor, and at least one computer-readable medium encoded with instructions which, when executed by the at least one processor, cause the system to determine that a user took a first action with respect to a first system of record after engaging in a first activity relating to a second system of record, to determine that the first activity is of a first activity type, to determine that the first action is of a first action type, to determine that the user has engaged in a second activity of the first activity type, and based at least in part on (A) the user having taken the first action after engaging in the first activity, (B) the first activity being of the first activity type, (C) the first action being of the first action type, and (D) the second activity being of the first activity type, to cause a client device to present a first user interface element that is selectable to enable the user to take a second action of the first action type with respect to the second system of record.

In some embodiments, at least one non-transitory computer-readable medium is encoded with instructions which, when executed by at least one processor of a computing system, cause the computing system to determine that a user took a first action with respect to a first system of record after engaging in a first activity relating to a second system of record, to determine that the first activity is of a first activity type, to determine that the first action is of a first action type, to determine that the user has engaged in a second activity of the first activity type, and based at least in part on (A) the user having taken the first action after engaging in the first activity, (B) the first activity being of the first activity type, (C) the first action being of the first action type, and (D) the second activity being of the first activity type, to cause a client device to present a first user interface element that is selectable to enable the user to take a second action of the first action type with respect to the second system of record.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example of how a display screen may present a list of recommended actions to a user after the user has engaged in a particular microapp-based activity in accordance with some aspects of the present disclosure;

FIG. 1B shows a high-level example implementation of a next action recommendation system configured in accordance with some aspects of the present disclosure;

FIG. 2 is a diagram of a network environment in which some embodiments of the context-based notification processing system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource management system, such as that shown in FIG. 5C, is employed;

FIG. 6 is a block diagram showing a more detailed example implementation of the next action recommendation system shown in FIG. 1B;

FIG. 7 shows an example routine that may be performed by the activity/action monitoring engine(s) shown in FIG. 6;

FIG. 8 shows an example routine that may be performed by the context determination engine shown in FIG. 6;

FIG. 9 shows an example routine that may be performed by the activity/action data upload engine shown in FIG. 6;

FIG. 10 shows an example routine that may be performed by the activity/action monitoring service shown in FIG. 6;

FIG. 11 shows an example table that the activity/action monitoring service shown in FIG. 6 may populate with data concerning detected activities/actions;

FIG. 12 shows an example routine that may be performed by the context classifier training service shown in FIG. 6;

FIG. 13 shows an example technique that the context classifier training service shown in FIG. 6 may use to train and/or update a predictive model for use by the next action forecasting service and the recommended action determination service;

FIG. 14A shows an example routine that may be performed by the next action forecasting service shown in FIG. 6;

FIG. 14B shows an example implementation of one or the steps of the example routine shown in FIG. 14A;

FIG. 15 shows an example table that the next action forecasting service shown in FIG. 6 may populate with user-specific next action forecast scores;

FIG. 16 shows an example routine that may be performed by the recommended action presentation engine shown in FIG. 6; and

FIG. 17 shows an example routine that may be performed by the recommended action determination service shown in FIG. 6.

### DETAILED DESCRIPTION

For purposes of reading the description of the various embodiments below, the following descriptions of the sections of the specification and their respective contents may be helpful:

Section A provides an introduction to example embodiments of a next action recommendation system;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E describes embodiments of systems and methods for managing and streamlining access by clients to a variety of resources;

Section F provides a more detailed description of example embodiments of next action recommendation system that was introduced above in Section A;

Section G describes example implementations of methods, systems/devices, and computer-readable media in accordance with the present disclosure.

### A. Introduction to Illustrative Embodiments of a Next Action Recommendation System

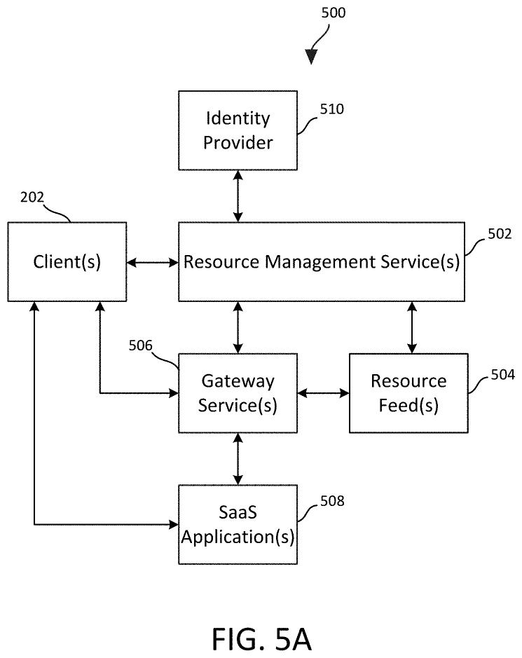

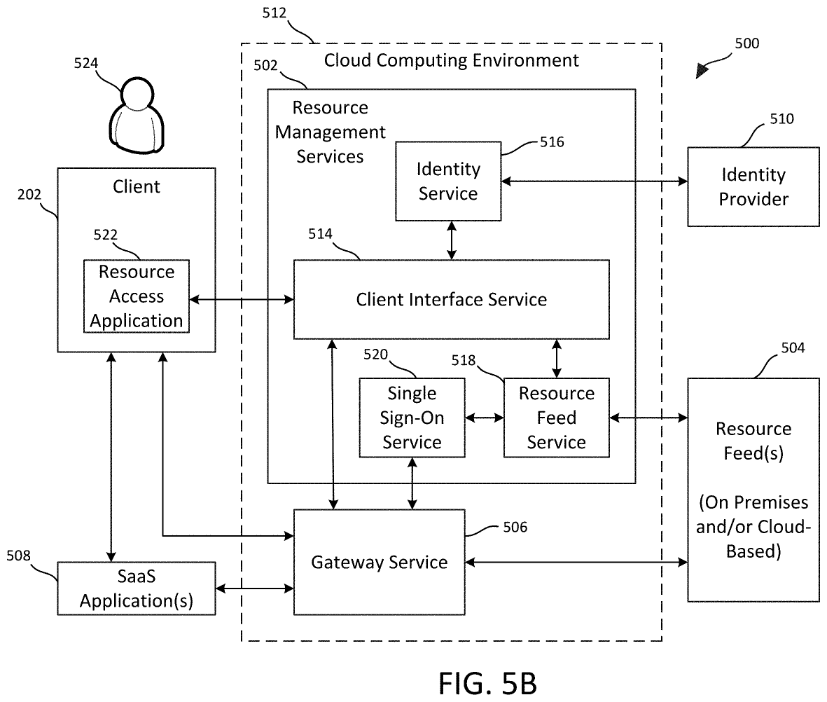

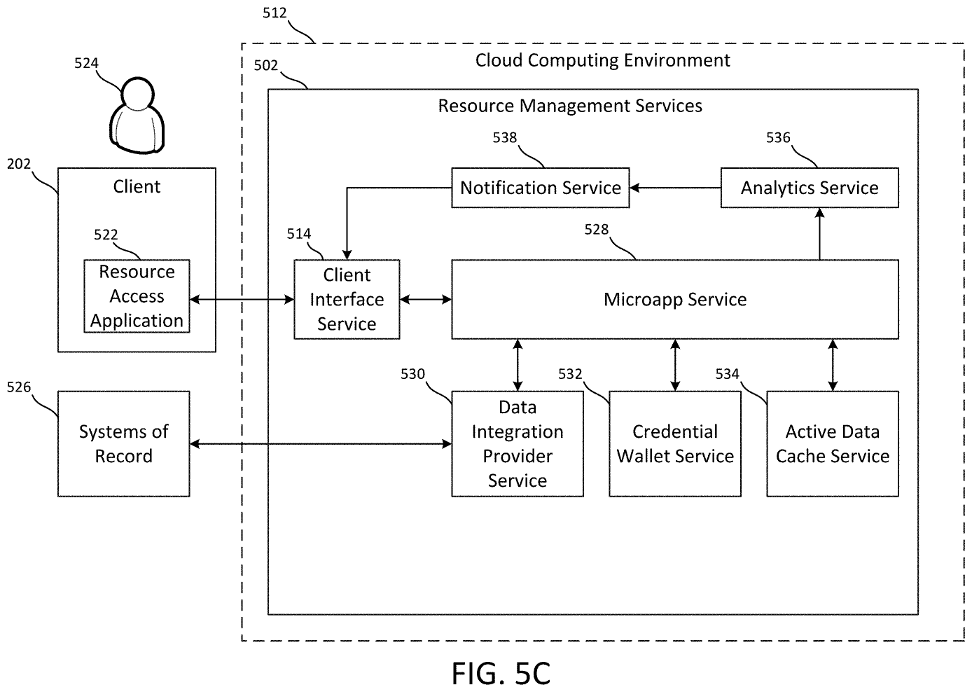

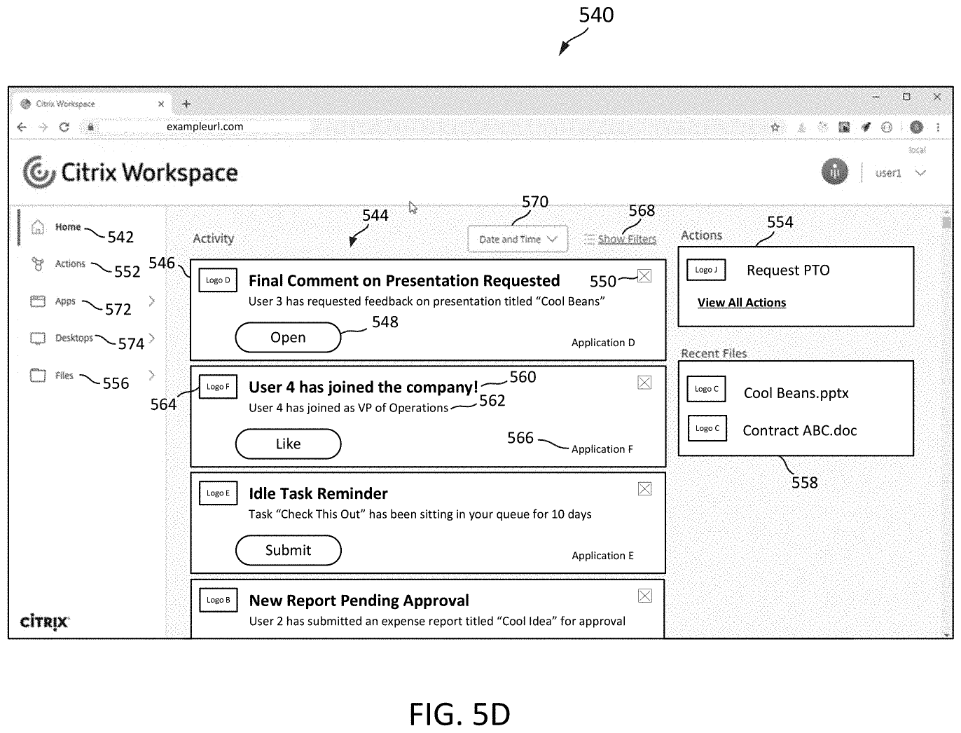

An intelligent activity feed, such as that offered by the Citrix Workspace™ family of products, provides significant benefits, as it allows a user to respond to application-specific events generated by disparate systems of record, without requiring the user to switch context and separately launch the respective applications to take actions with respect to the different events. An example of a system capable of providing such an activity feed is described in Section E below in connection with FIGS. 5A-D. In such a system, a remote computing system may be responsible for monitoring and interacting with various systems of record (e.g., SaaS applications, web applications, Windows applications, Linux applications, desktops, file repositories and/or file sharing systems, etc.) on behalf of a user operating a client device. As Section E describes (in connection with FIGS. 5C and 5D), a user 524 may operate a client device 202 so as to interact with “microapps” corresponding to particular functionalities of a variety of systems of record 526, and such microapps may, in turn, interact with the systems of record 526, e.g., via application programming interfaces (APIs) of such systems, on behalf of the user 524.

More specifically, and as described in more detail in Section E, a microapp service 528 (shown in FIG. 5C) may periodically request a sync with a data integration provider service 530, so as to cause active data to be pulled from the systems of record 526. In some implementations, for example, the microapp service 528 may retrieve encrypted service account credentials for the systems of record 526 from a credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to an analytics service 536 for processing. The analytics service 536 may create notifications (e.g., targeted scored notifications) and send such notifications to the notification service 538. The notification service 538 may store the notifications in a database to be later served in an activity feed and/or may send the notifications out immediately to the client 202 as a push notification to the user 524.

FIG. 5D, which is also described in more detail in Section E, shows how a display screen 540 presented by a resource access application 522 (shown in FIG. 5C) may appear when an intelligent activity feed feature is employed and a user 524 is logged on to the system. As shown in FIG. 5D, an activity feed 544 may be presented on the display screen 540 that includes a plurality of notifications 546 about respective events that occurred within various applications to which the user 524 has access rights. As described below (in connection with FIG. 5D), in some implementations, when presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550.

As explained in connection with FIG. 5C below, the notifications 546 and corresponding action elements 548 may be implemented, for example, using “microapps” that can read and/or write data to systems of record 526 using application programming interface (API) functions or the like, rather than by performing full launches of the applications for such systems of record 526. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification 546 via that native application rather than via the microapp.

In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of recently and/or commonly used microapp actions. The inventors have recognized and appreciated that, while it can be beneficial in many circumstances for a user to have ready access to the list 554 of recently and/or commonly used actions, situations can arise in which, after accessing a notification 546 in the activity feed 544, a user might want to take an action that is not on the list 554 as it is currently configured. In this regard, the inventors have also recognized and appreciated that users oftentimes perform tasks in similar sequences. For example, after completing an engineering-related task, a user may commonly update a task management application (e.g., Jira) to reflect that the task has been completed. Or, as another example, a user may commonly submit an expense report after entering details of a new client prospect into a customer management application (e.g., Salesforce).

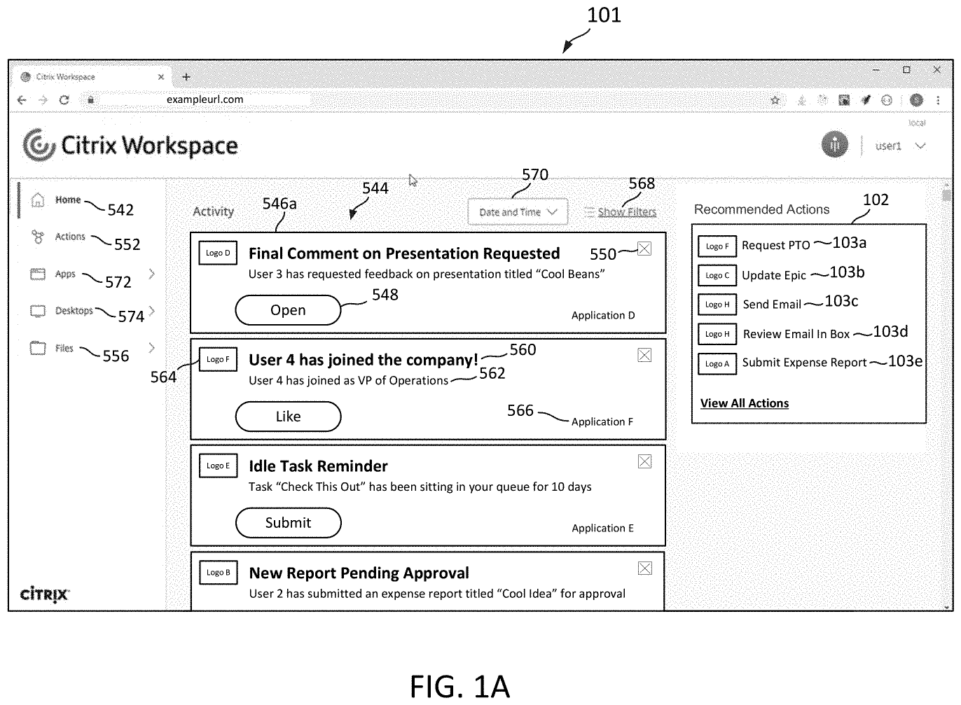

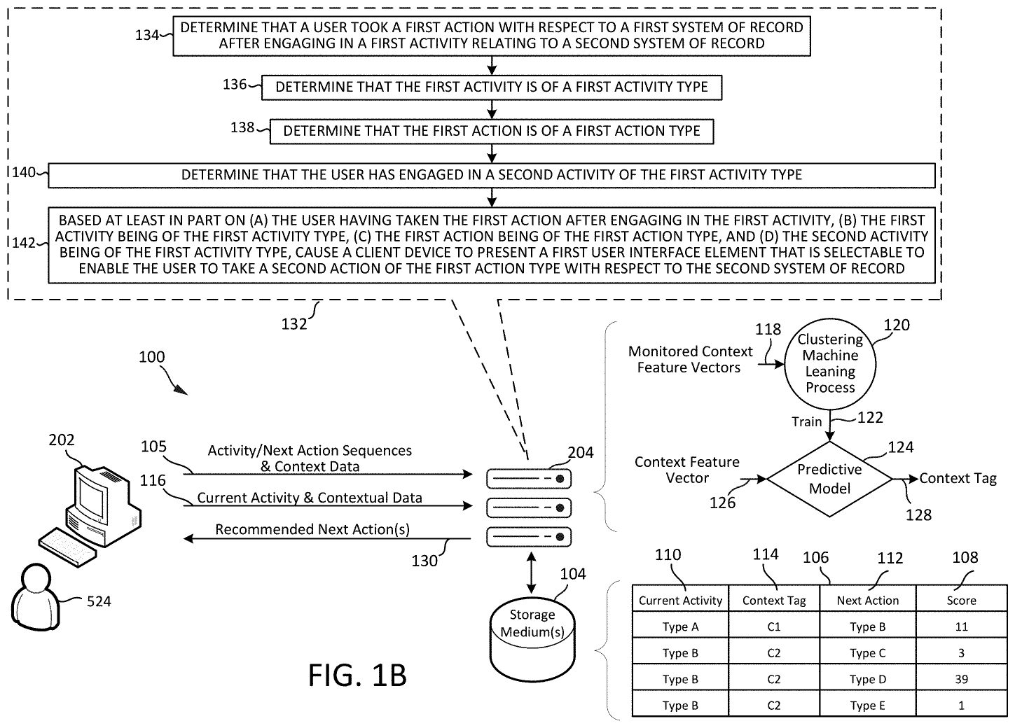

Offered is a system that can take a user's historical behavior patterns with respect to sequences of “activities” followed by “actions” (referred to herein alternatively as “activity/action sequences”) into account to determine one or more suggested actions to present to a user, e.g., via a “recommended actions” list similar to the list 554 noted above, based on the activity in which the user 524 is currently engaged. FIG. 1A shows an example screen 101 that includes, on the right-hand side, a recommended actions list 102 configured in accordance with some embodiments of the present disclosure. The recommended actions list 102 may, for example, be presented on the client device 202 after the user 524 clicks on or otherwise selects a particular notification 546 on the screen 540 (shown in FIG. 5D), such as the notification 546a shown in FIG. 1A, and/or accesses a user interface window for a particular microapp by clicking on a notification 546 or otherwise.

As shown in FIG. 1A, in some implementations, in response to a user engaging in a particular activity, e.g., by clicking on or otherwise selecting a notification 546 in the activity feed 544 and/or accessing a user interface window for a microapp, one or more user interface elements (e.g., links) 103a-103e for suggested next actions may be presented on the display screen 101. Various techniques are described below for tracking a given user's typical activity/action sequences to determine the next actions that user is most likely to take after engaging in specific activities. In some implementations, data concerning the context of a user's device (e.g., time of day, day of week, location, network connection, device type, etc.) when such activity/action sequences occur may likewise be tracked and used to more accurately predict the next actions the user is most likely to take after engaging in specific activities in given contextual scenarios.

FIG. 1B shows an example implementation of a next action recommendation system 100 (alternatively referred to herein as simply “the system 100”) configured in accordance with some aspects of the present disclosure. As shown, the system 100 may include one or more servers 204 (examples of which are described below) as well as one or more databases or other storage mediums 104 that are accessible by the server(s) 204. As indicated by an arrow 105 in FIG. 1B, the system 100 may monitor interactions of a user 524 with one or more applications of client device(s) 202 the user 524 operates, e.g., the resource access application 522 (shown in FIG. 5C) and/or a web browser, and may send data to the server(s) 204 indicative of occasions on which the user 524 operates the monitored application(s) to take specific actions after engaging in particular activities.

In some instances, a user may engage in such activities and/or take such next actions indirectly with respect to systems of record 526, such as by taking advantage of functionality provided by one or more microapps. For example, as described in Section E below, the respective notifications 546 in the user's activity feed 544 may be associated with microapps of the microapp service 528 (shown in FIG. 5C). In such a case, clicking on a notification 546 may cause a user interface window for the associated microapp to be presented on the client device 202, so as to allow the user 524 to engage in an activity and/or take a next action with respect to the system of record 526 with which the microapp is associated. In other instances, microapp user interface windows may be accessed via one or more links separate from the notifications 546, such as via the “actions” user interface element 552 (shown in FIGS. 1A and 5D) and/or a list of available actions, such as the list 554 of recent and/or commonly used actions (shown in FIG. 5D) or the recommended actions list 102 shown in FIG. 1A. As explained in detail below, in some implementations, functionality may be added to the resource access application 522 to monitor user interactions with respective notifications 546 and/or their associated user interface windows, and data concerning those interactions, and perhaps also the context of the user's client device 202 when such interactions take place, may be sent to the server(s) 204 as indicated by the arrow 105 in FIG. 1B.

In other instances, the user 524 may interface directly with an application, e.g., a SaaS application, to engage in an activity and/or take a next action. In some implementations, for example, a plug-in or add-in may be included in a web browser that is used to access such applications so as to allow the user's interactions with various web pages to be monitored, and data concerning those interactions, and perhaps also the context of the user's client device 202 when such interaction take place, may additionally or alternatively be sent to the servers(s) 204 as indicated by the arrow 105 in FIG. 1B.

As explained in detail below, the server(s) 204 may store records of the monitored activities/actions of the user 524 for subsequent analysis to determine one or more recommended next actions when the user 524 is engaged in particular activities. After receiving data and creating records for a sufficient number of the aforementioned user interactions, and possibly also context data of the client device 202 when such interactions occurred, the server(s) 204 may evaluate some period of the stored historical records (e.g., for the previous twenty days), and may generate summary data indicative of the tendency of the user 524 to take certain actions after engaging in particular activities. FIG. 1B shows example entries in a table 106 that may be populated with such summary data. As shown, in some implementations, the summary data in the table 106 may include “next action forecast scores” (see “score” entries 108) that may be calculated based on how many times the user transitioned from a current activity (see “current activity” entries 110) to a next action (see “next action” entries 112) during the period being considered. In some implementations, the system 100 may exclude from consideration instances in which the time period between ending the current activity and beginning to take the next action is greater than a threshold time period and/or may adjust the forecast scores based on the lengths of such time periods, e.g., so that activity/action sequences with longer intervening time periods have less of an influence on the forecast score. Example techniques for calculating next action forecast scores based on historical user-specific interaction data for a given time interval are described further below.

As shown in the illustrated example, a context tag (see “context tag” entries 114) may also be assigned to the respective activity/action sequences reflected in the table 106. As explained in detail below, in some implementations, once a sufficient quantity of historical context data for a user 524 has been collected, a clustering process may be used to find one or more clusters of similar contextual scenarios represented by the data, and the results of such a clustering process may be used to train a predictive model that can assign, for a particular user, a context tag based on a given context data sample. For example, as illustrated in FIG. 1B, in some implementations, the system 100 may convert the context data for respective activities/actions into feature vectors 118 (e.g., using one or more encoders—not shown in FIG. 1B), with the context data of each activity/action being represented by a respective multi-dimensional feature vector 118. The system 100 may then provide those feature vectors 118 to a machine learning process 120 which may, for example, perform an unsupervised machine learning technique to identify clusters of data points in a multi-dimensional space. The dimensions of a given feature vector in the multi-dimensional space may, for example, correspond to the respective pieces of context data that were determined for a particular activity/action. In some implementations, such pieces of context data may, for example, include (A) a device ID identifying the client device 202 used to engage in the activity or take the action, (B) the time of day at which the interaction occurred, (C) the day of the week on which the interaction occurred, (D) a network ID identifying the network to which the client device 202 was connected when the interaction occurred, and (E) a location (e.g., latitude and longitude) of the client device 202 when the interaction occurred.

The machine learning process 120 may then be used to train 122 a predictive model 124 to categorize respective input feature vectors 126 into one of the clusters that were identified using the clustering process. Once it is properly trained, the predictive model 124 may be used to assign labels, referred to herein as “context tags,” to the records of the activity and/or action data that it received from the client device(s) 202. In particular, for respective ones of the activity/action records, the stored contextual information for the record may be converted into a feature vector 126, e.g., using one or more encoders, that is then provided to the predictive model 124 for classification into a particular cluster. The predictive model 124 may, for example, output context tags 128 corresponding to the clusters into which it classifies the input feature vectors 126.

In some implementations, the system 100 may periodically (e.g., once per day) evaluate at least some of the stored activity/action records, including the context tags 128 applied to them by the predictive model 124, to determine forecast scores for the possible combinations of current activities, next actions, and context tags that are reflected in the evaluated data sets for respective users 524. In some implementations, for example, the system 100 may use the stored activity/action records for a set period of time (e.g., the prior 20 days) to determine the next action forecast scores for respective users 524.

With respect to the four rows in the sample table 106 shown in FIG. 1B, the first row indicates that a next action forecast score of “11” has been calculated for a transition from a current activity of “type A” to a next action of “type B” when the client device 202 operated by the user 524 is in a contextual scenario corresponding to the context tag “C1.” Similarly, the second row in the table 106 indicates that a next action forecast score of “3” has been calculated for a transition from a current activity of “type B” to a next action of “type C” when the client device 202 operated by the user 524 is in a contextual scenario corresponding to the context tag “C2.” The third row in the table 106 indicates that a next action forecast score of “39” has been calculated for a transition from a current activity of “type B” to a next action of “type D” when the client device 202 operated by the user 524 is in a contextual scenario corresponding to the context tag “C2.” Finally, the fourth row in the table 106 indicates that a next action forecast score of “1” has been calculated for a transition from a current activity of “type B” to a next action of “type E” when the client device 202 operated by the user 524 is in a contextual scenario corresponding to the context tag “C2.”

As explained in more detail below, in some implementations, the system 100 may use the forecast scores in the table 106 (as indicated by the “scores” entries 108) to select one or more next actions (as indicated by the “next action” entries 112) to recommend to the user 524 when the user 524 is engaged in a particular activity (as indicated by the “current activity” entries 110) while operating a client device 202 in a particular contextual scenario (as indicated by the “context tag” entries 114). As indicated by an arrow 116 in FIG. 1B, for example, in some implementations, the client device 202 may send to the server(s) 204 an indication of the activity in which user 524 is currently engaged (e.g., a particular notification 546 the user 524 has selected and/or a particular microapp user interface window the user 524 is viewing), as well as an indication of the current context of the client device 202 (e.g., time of day, day of week, location, network connection, device type, etc.). Similar to the context data that the system 100 accumulated during the activity/action monitoring process discussed above, examples of current context data that may gathered and sent to the server(s) 204 include (A) a device ID identifying the client device 202, (B) the current time of day, (C) the current day of the week, (D) a network ID identifying the network to which the client device 202 is currently connected, and (E) a current location (e.g., latitude and longitude) of the client device 202.

Upon receiving the current context data from the client device 202 (e.g., per the arrow 116), the system 100 may encode the received context data into a feature vector 126 and provide that feature vector 126 to the predictive model 124 for determination of a context tag 128. After the context tag 128 has been determined for the current contextual information, the table 106 may be consulted to determine one or more recommended next actions to communicate to the client device 202, e.g., as indicated by an arrow 130 in FIG. 1B.

In some implementations, to determine one or more appropriate next actions, the system 100 may, for example, identify the rows of the table 106 that include (A) “current activity” entries 110 of the same type as the current activity indicated by the received data (corresponding to the arrow 116 in FIG. 1B), and (B) “context tag” entries 114 that are the same as the context tag assigned to the received context data. The system may then use the forecast scores in the identified rows to select one or more next actions to recommend to the user 524. For example, in some implementations, the system 100 may select one or more of the next action types (as indicated by the “next action” entries 112) that are indicated in the rows for which the forecast scores are the highest. Further, in some implementations, the system 100 may refrain from selecting next action types that are indicated in rows for which the forecast scores are below a threshold value. For instance, with reference to the table 106, if the current activity indicated by the data received from the client device 202 is “type B,” the context data received from the client device 202 is assigned a context tag “C2,” and the threshold forecast score is “2,” the system 100 may recommend the “type C” action and the “type D” action, but not the “type E” action, because the forecast score for the “type E” action in that circumstance (i.e., a score of “1”) is below the threshold. In some implementations, the system 100 may further rank the “type D” action higher than the “type C” action, e.g., by presenting it higher on the recommended actions list 102 (shown in FIG. 1A), because the type “D” action has a higher forecast score (i.e., “39”) than the “type C” action (i.e., “3”).

As indicated by the arrow 130 in FIG. 1B, after the system has determined one or more next actions to recommend to the user 524 based on the current activity in which the user is engaged and the current context of the client device 202 the user 524 is operating, the server(s) 204 may communicate the identified next actions to the client device 202 for presentation to the user 524. In some implementations, for example, the resource access application 522 may present the recommended next actions in a particular region of a display screen. For example, the recommended next actions may be presented as the recommended actions list 102 shown in FIG. 1A, in addition to or in lieu of the list 554 of recently and/or commonly used microapp actions shown in FIG. 5D.

In some implementations, the recommended actions list 102 may include selectable user interface elements (e.g., links 103a-e—shown in FIG. 1A) for the respective next actions on the list, and the system 100 may be configured to enable to the user 524 to readily perform the respective actions upon selecting such user interface elements 103. For example, in some implementations, the system 100 may, upon detecting selection of one or more of the user interface elements 103a-e, cause a user interface window for a microapp to be presented, where the microapp may be configured to allow the user 524 to take the recommended next action seamlessly, such as by selecting an action element included in the user interface window for the microapp.

Further, in some implementations, the system 100 may, upon detecting selection of one or more of the user interface elements 103a-e for the recommended next actions, cause the client device 202 (e.g., using a web browser) to launch and/or access a particular page of a SaaS application from which the user 524 can seamlessly take the corresponding recommended next action. As described in Section E, for example, when the system 100 is included in or operates in conjunction with a multi-resource access system 500 (shown in FIGS. 5A-C), the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508. Further, as noted previously, in some implementations, in addition to launching the SaaS application 508, the resource access application 522 may also cause the web browser to access a particular page of the SaaS application from which the user can seamlessly take the recommended next action corresponding to the selected link 103.

FIG. 1B further shows an example routine 132 that may be performed by the server(s) 204 of the next action recommendation system 100 in accordance with some embodiments.

As shown, at a step 134 of the routine 100, the server(s) 204 may determine that the user 524 took a first action with respect to a first system of record (e.g., by taking an action using a first microapp or a SaaS application) after engaging in a first activity relating to a second system of record (e.g., by selecting a first type of notification 546 and/or interacting with a user interface window of a second microapp).

At a step 136, of the routine 100, the server(s) 204 may determine that the first activity is of a first activity type.

At a step 138, of the routine 100, the server(s) 204 may determine that the first action is of a first action type (e.g., involving the first microapp or a particular function of the SaaS application).

At a step 140, of the routine 100, the server(s) 204 may determine that the user 524 has engaged in a second activity of the first activity type (e.g., by selecting another notification of the first type and/or again interacted with a user interface window of the second microapp).

At a step 142, of the routine 100, the server(s) 204 may, based at least in part on (A) the user having taken the first action after engaging in the first activity, (B) the first activity being of the first activity type, (C) the first action being of the first action type, and (D) the second activity being of the first activity type, cause the client device 202 to present a first user interface element (e.g., a link 103 on the recommended actions list 102) that is selectable to enable the user to take a second action of the first action type with respect to the second system of record (e.g., involving the first microapp or the particular function of the SaaS application).

Additional details and example implementations of embodiments of the present disclosure are set forth below in Section F, following a description of example systems and network environments in which such embodiments may be deployed.

### B. Network Environment

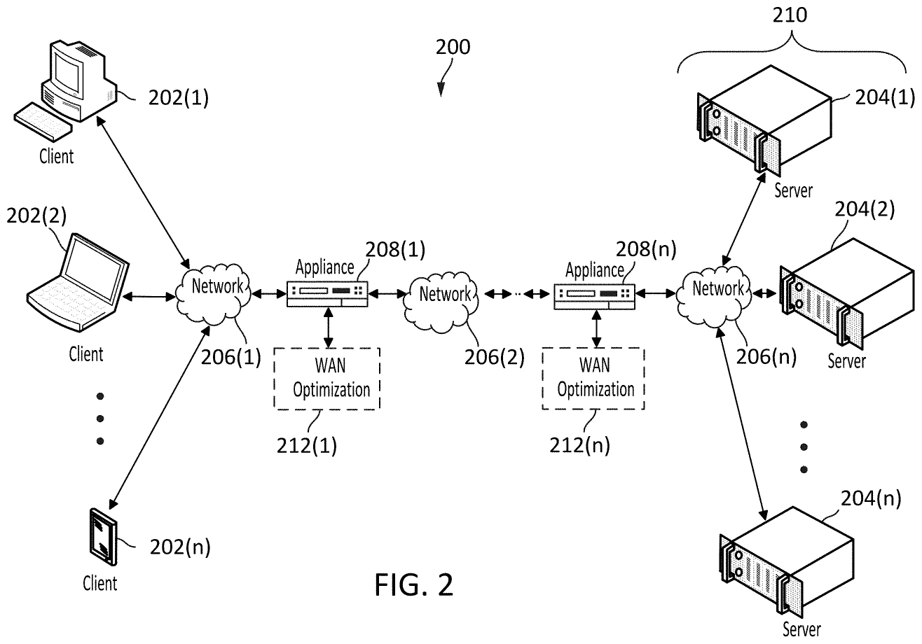

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

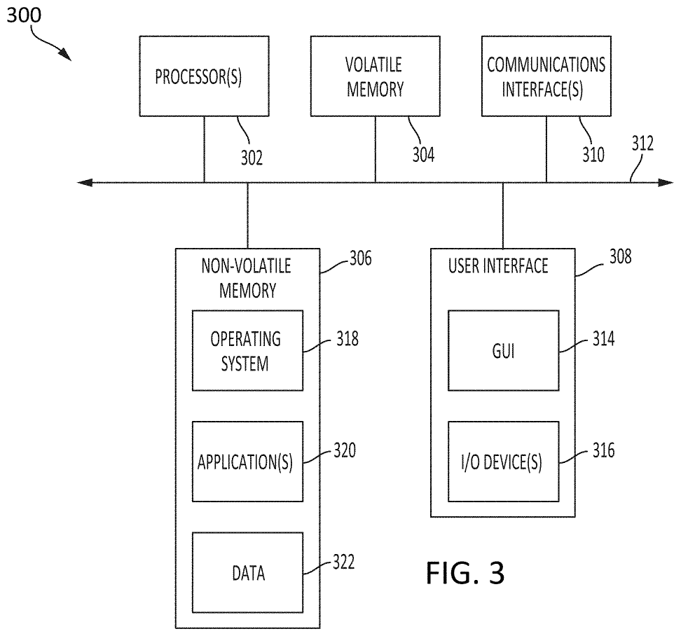

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

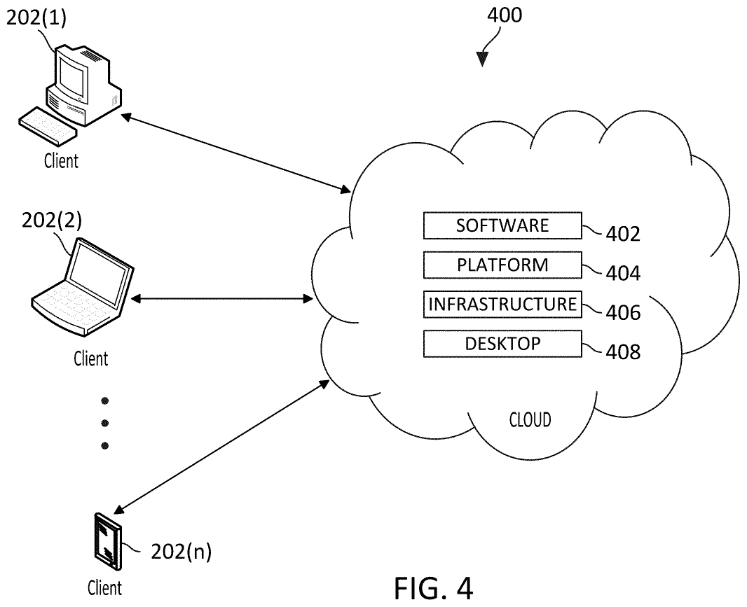

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource application is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one or more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D), a “relevancy” mode (not illustrated) may be selected (e.g., using the element 570) in which the notifications may be sorted based on relevancy scores assigned to them by the analytics service 536, and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of recently and/or commonly used microapp actions. As shown, additional resources may also be accessed through the screen 540 by clicking on or otherwise selecting one or more other user interface elements that may be presented on the screen. For example, in some embodiments, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 572 to reveal a list of accessible applications or by selecting a desired application from a list (not shown in FIG. 5D but similar to the list 558) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 574 to reveal a list of accessible desktops or by or by selecting a desired desktop from a list (not shown in FIG. 5D but similar to the list 558) of recently and/or commonly used desktops.

The activity feed shown in FIG. 5D provides significant benefits, as it allows a user to respond to application-specific events generated by disparate systems of record without needing to navigate to, launch, and interface with multiple different native applications.

### F. Detailed Description of Example Embodiments of the Next Action Recommendation System Introduced in Section A

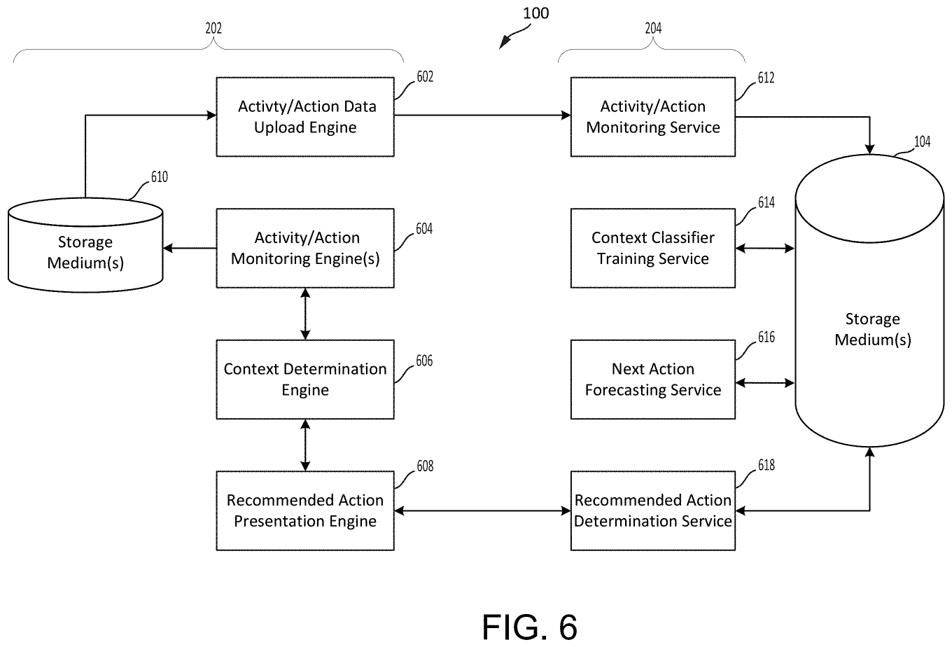

FIG. 6 shows example components that may be included in the next action recommendation system 100 introduced above in Section A. As shown, in some implementations, some components of the system 100 may be embodied within the client device(s) 202 and other components of the system 100 may be embodied within the server(s) 204. In particular, as illustrated, in some implementations, the client device(s) 202 may include an activity/action data upload engine 602, one or more activity/action monitoring engine(s) 604, a context determination engine 606, a recommended action presentation engine 608, and one or more storage mediums 610. In some implementations, the engines 602, 604, 606 and 608 may, for example, be components of, or operate in conjunction with, the resource access application 522 described above in connection with FIGS. 5B and 5C. Further, as also illustrated in FIG. 6, in some implementations, the server(s) 204 may include an activity/action monitoring service 612, a context classifier training service 614, a next action forecasting service 616, and a recommended action determination service 618. In some implementations, the services 612, 614, 616 and 618 may, for example, be included amongst, or operate in conjunction with, the resource management services 502 described above in connection with FIGS. 5B and 5C.

In some implementations, the storage medium(s) 610 may be encoded with instructions which, when executed by one or more processors of the client device(s) 202, may cause the client device(s) 202 to perform the functions of the engines 602, 604, 606, and 608 described herein. Similarly, in some implementations, the storage medium(s) 104 may be encoded with instructions which, when executed by one or more processors of the server(s) 204, may cause the server(s) 204 to perform the functions of the services 612, 614, 616, and 618 described herein.

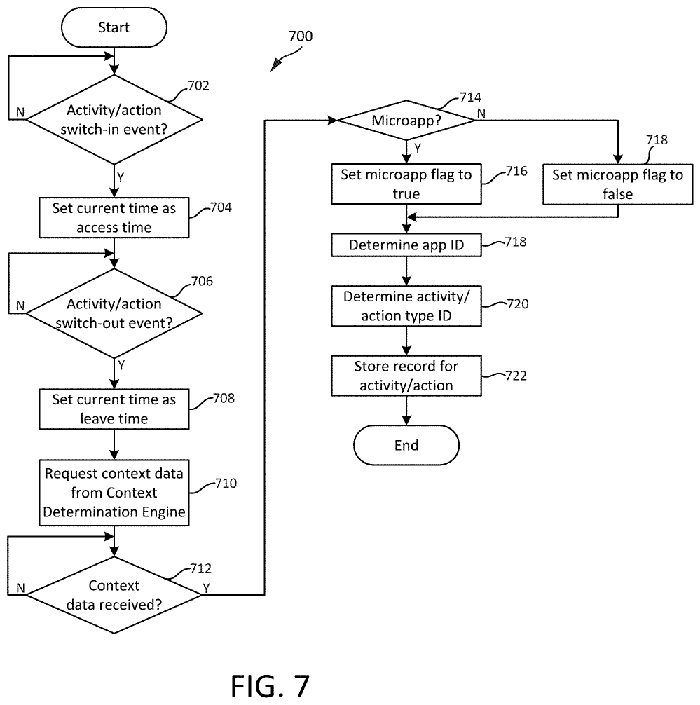

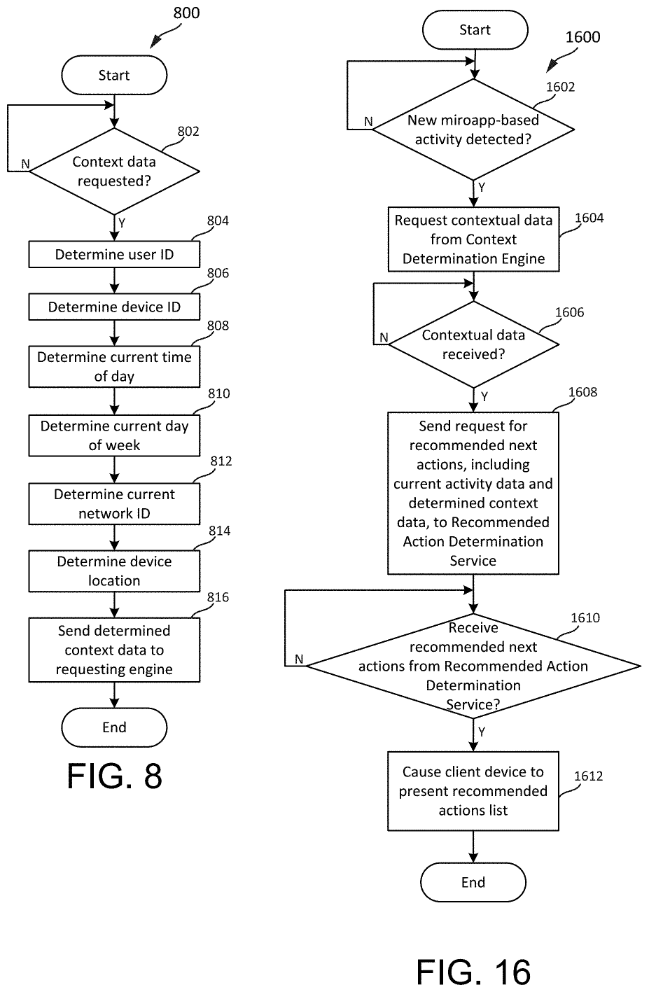

At a high level, the activity/action monitoring engine(s) 604 may monitor a user's interactions with one or more applications of client device(s) 202 the user operates (e.g., the resource access application 522 and/or a web browser) and may record data indicative of occasions on which the user 524 engages in particular activities and/or takes particular actions relating, directly or indirectly, to one or more systems of record 526. For instance, as noted above in Section A, in some implementations, functionality may be added to the resource access application 522 to detect and record data indicative of instances in which a user 524 selects notifications 546 or otherwise accesses user interface windows for microapps. As also noted above, in some implementations, functionality may additionally or alternatively be added to a web browser to detect and record data indicative of instances in which the user 524 performs certain tasks with respect to software-as-a-service (SaaS) applications. The activity/action monitoring engine(s) 604 may, for example, create records of such activities/actions in the storage medium(s) 610. As described in more detail below, the activity/action monitoring engine(s) 604 may additionally request current context data from the context determination engine 606, and may record such context data in the storage medium(s) 610 as part of those created records. As noted in Section A, examples of such context data that may be so determined and included in the records include (A) device IDs identifying the particular client devices 202 used to engage in the activities and/or take the actions, (B) the times of day the client devices 202 were used to engage in the activities and/or take the actions, (C) the days of the week the client devices 202 were used to engage in the activities and/or take the actions, (D) network IDs identifying the networks to which the client devices 202 were connected when they were used to engage in the activities and/or take the actions, (E) the locations (e.g., latitudes and longitudes) of the client devices 202 when they were used to engage in the activities and/or take the actions. An example routine 700 that may be performed by the activity/action monitoring engine(s) 604 is described below in connection with FIG. 7. An example routine 800 that may be performed by the context determination engine 606 is described below in connection with FIG. 8.

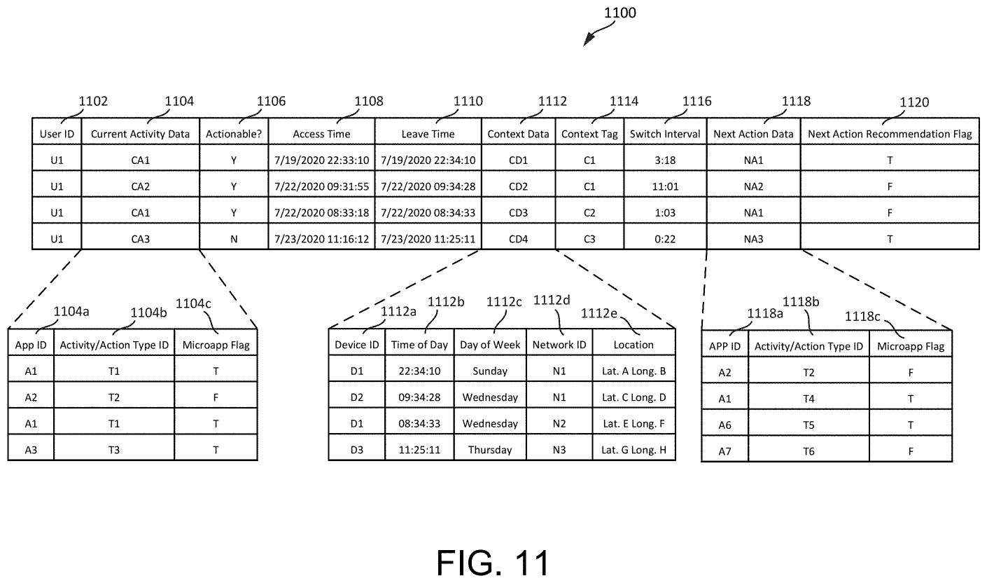

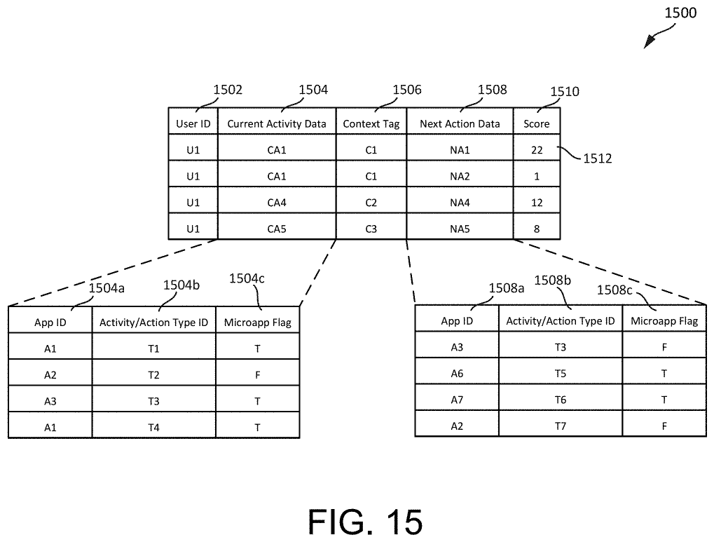

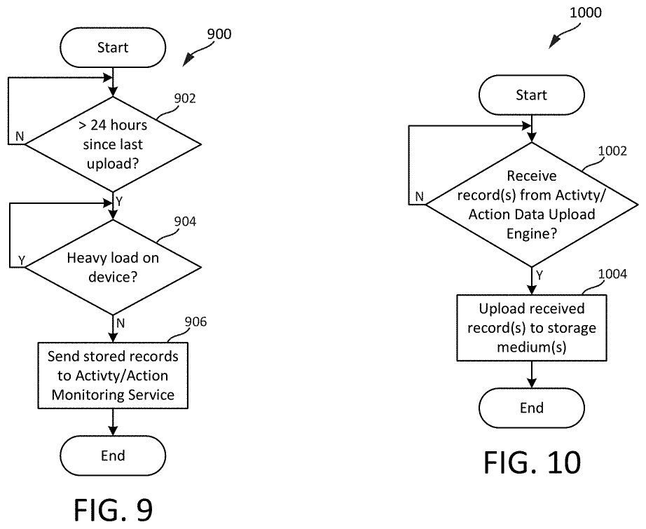

The activity/action data upload engine 602 may be responsible for uploading the new records created by the activity/action monitoring engine(s) 604 from the storage medium(s) 610 to the activity/action monitoring service 612. As explained below, in some implementations, such record uploads may be performed periodically, e.g., once per day, at a time when the computational load on the client device 202 is low. An example routine 900 that may be performed by the activity/action data upload engine 602 is described below in connection with FIG. 9.

The activity/action monitoring service 612 may receive the records, including the context data determined by the context determination engine 606, that are uploaded from the activity/action data upload engine 602, and may write those records to the storage medium(s) 104, e.g., as rows in one or more tables. An example routine 1000 that may be performed by the activity/action monitoring service 612 is described below in connection with FIG. 10. An example table 1100 that may be populated with data for respective activities/actions, including empty fields for context tags 128 and other data items that are to be subsequently determined by the next action forecasting service 616 (as explained below), is described below in connection with FIG. 11.

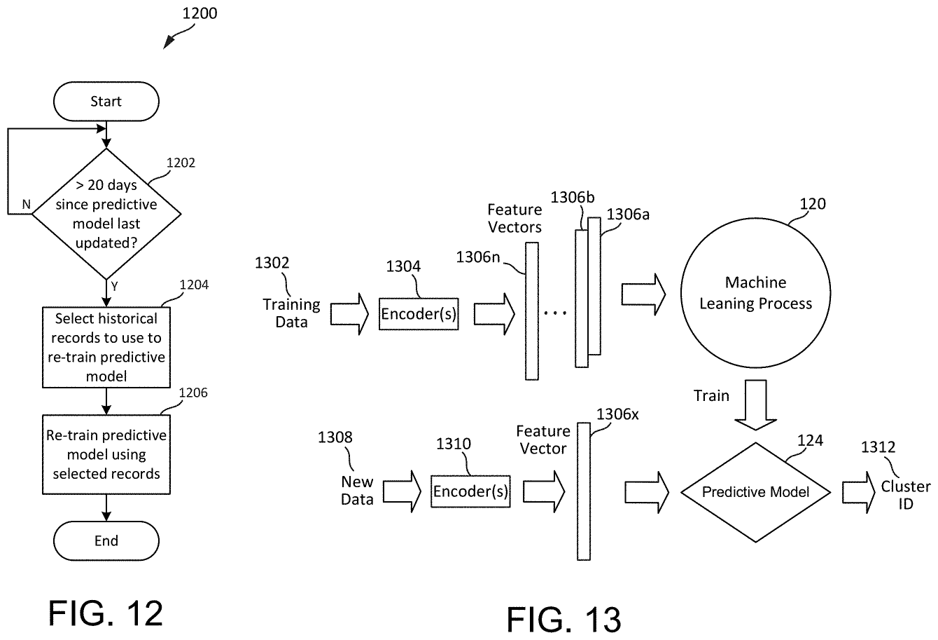

The context classifier training service 614 may be responsible for training and/or updating the predictive model 124 that is used by the next action forecasting service 616 and the recommended action determination service 618, as explained below. An example routine 1200 that may be performed by the context classifier training service 614 is described below in connection with FIG. 12. Example techniques that may be used to train the predictive model 124 using a collection of context data samples, as well as to use the predictive model 124 to determine a context tag 128 for a given context data sample, are described below in connection with FIG. 13.

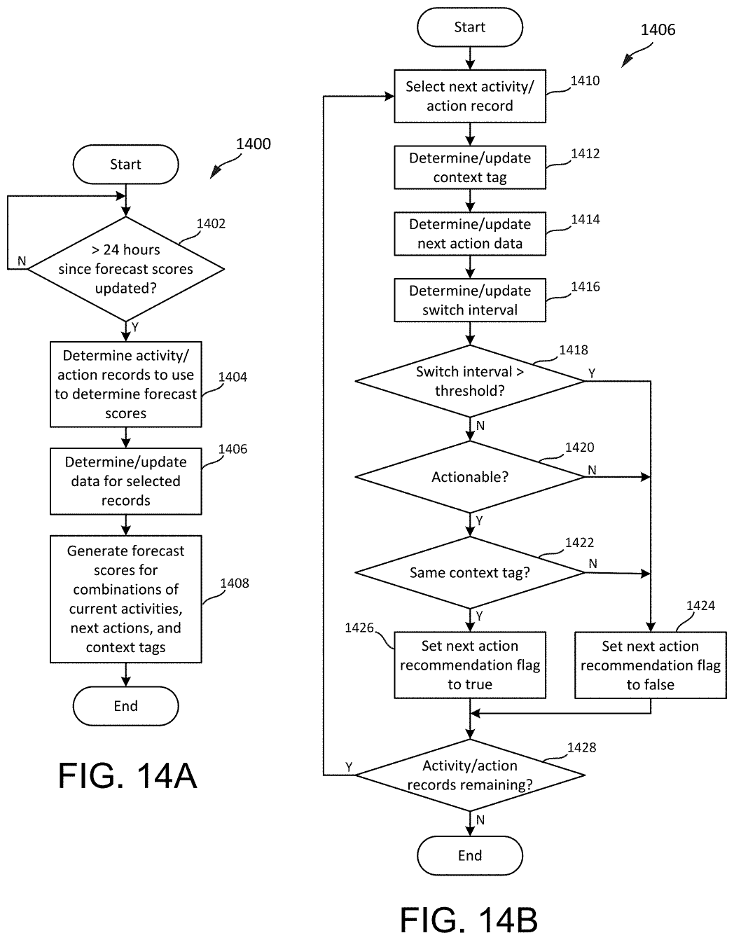

The next action forecasting service 616 may be responsible for calculating context-based next action forecast scores that can subsequently be used by the recommended action determination service 618 to determine the types of actions that are to be included in recommended actions list 102 based on the current contextual situation of that client device 202. For example, as explained in more detail below, in some implementations, the next action forecasting service 616 may periodically (e.g., once per day): (A) select a subset of the data in the table 1100 that is to be used for next action forecasting purposes (e.g., data from the past twenty days), (B) use the predictive model 124 to update the context tags 128 for the respective context data samples in the selected data subset, (C) update the “actionable?” entries 1104, the “switch interval” entries 1116, the “next action data” entries 1118, and the “next action recommendation flag” entries 1120, for the records in selected data subset, (D) generate a “next action forecasting table” 1500 (an example of which is shown in FIG. 15) representing the various combinations of current activities, next actions, and context tags within the selected data subset, and (E) calculate next action forecast scores for the respective combinations represented in the table 1500. An example routine 1400 that may be performed by the next action forecasting service 616 is described below in connection with FIGS. 14A-B. An example table 1500 populated with next action forecast scores (determined by the next action forecasting service 616) for a given user (i.e., the user 524 with user ID “U1”) is described below in connection with FIG. 15.

The recommended action presentation engine 608 of the client device(s) 202 and the recommended action determination service 618 of the server(s) 204 may operate together to present a user 524 of a client device 202 with the recommended actions list 102. In particular, in some implementations, the recommended action presentation engine 608 may determine that the user 524 has started a new activity (e.g., by clicking on a new notification 546) and that the system 100 should thus present the user 524 with a new recommended actions list 102 based on that new activity. In response to making such a determination, the recommended action presentation engine 608 may acquire current context data (e.g., from the context determination engine 606) and may send a request for recommended next actions to the recommended action determination service 618, together an indication of the new activity as well as the determined context data.

Upon receiving the request for recommended next actions and the current context data from the client device 202, the recommended action determination service 618 may use the predictive model 124 to determine a context tag 128 for the current context data. For example, the recommended action determination service 618 may encode the received context data into a feature vector 126 and then feed that feature vector 126 to the predictive model 124 to as to yield a context tag 128 based on the current context data. Alternatively, in some implementations, the predictive model 124, when generated and/or updated, may be provided to the client device(s) 202, so as to enable the client device(s) 202 to instead determine the context tags 128 for respective context data samples. In any event, once the recommended action determination service 618 has the context tag 128 based on the current context data, the recommended action determination service 618 may reference the table 1500 to identify one or more recommended next actions. In some implementations, for example, one or more next action types (e.g., as indicated by the “next action data” entries 1508 in the table 1500) that are identified in rows of the table 1500 which (A) have “current activity data” entries 1504 that correspond to the new activity, (B) have the same context tag 128 as the current context data, and (C) have higher than a threshold next action forecast score (e.g., as indicated by the “score” entries 1510), may be selected as the actions that are to be included in the recommended actions list 102. In some implementations, the recommended action determination service 618 may further use the next action forecast scores to select a subset of the actions meeting the foregoing criteria and/or to determine an order in which the identified actions are to be included in the recommended actions list 102, such as by placing actions with higher scores higher up on the list 102.

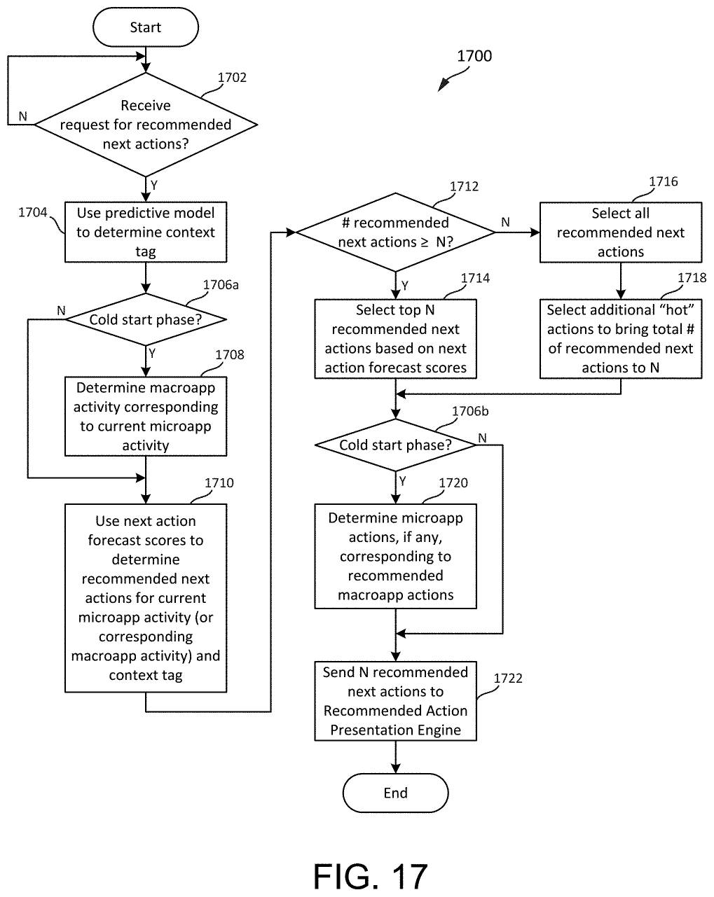

After the recommended action determination service 618 has determined the recommended next actions for the user 524, e.g., based on the entries in the table 1500, the recommended action determination service 618 may send data identifying the recommended next actions to the recommended action presentation engine 608. In some implementations, the next action forecast scores (e.g., in the table 1500) may additionally be sent to the recommended action presentation engine 608, so as to allow the recommended action presentation engine 608 to determine the order in which the identified recommended next actions appear in the recommended actions list 102. For example, the recommended next actions having higher next action forecast scores in the table 1500 may, in at least some circumstances, be caused to appear higher on the recommended actions list 102 than those having lower next action forecast scores. An example routine 1600 that may be performed by the recommended action presentation engine 608 is described below in connection with FIG. 16. An example routine 1700 that may be performed by the recommended action determination service 618 is described below in connection with FIG. 17.

As noted above, FIG. 7 shows an example routine 700 that may be performed by the activity/action monitoring engine(s) 604 shown in FIG. 6. As shown, the routine 700 may begin at a decision step 702, at which the activity/action monitoring engine(s) 604 may detect a “switch-in event” for an activity or action. In some implementations, certain detected user interactions with the resource access application 522 and/or a web browser may be considered indicative of a user beginning a new activity or action. For example, in some implementations, an activity/action monitoring engine 604 for the resource access application 522 may determine that an activity/action switch-in event has taken place when a user 524 (A) clicks on or otherwise selects an action element 548 within a notification 546 so as to cause a corresponding microapp to perform a particular task, (B) clicks on or otherwise selects a notification 546 to reveal a user interface window for a microapp associated with the notification 546, and/or (C) clicks on or otherwise selects a link (e.g., one of the links 103a-e shown in FIG. 1A) to reveal a user interface window for a microapp. Additionally or alternatively, in some implementations, an activity/action monitoring engine 604 for a web browser may determine that an activity/action switch-in event has taken place when a user 524 (A) launches a SaaS application, (B) clicks on particular links or otherwise causes the web browser to request that the SaaS application perform certain functions, and/or (C) clicks on particular links or otherwise causes the web browser to request particular types of content (e.g., certain pages or forms) from a SaaS application. As indicated, the routine 700 may proceed to a step 704 when such activity/action switch-in event is detected.

At the step 704 of the routine 700, the activity/action monitoring engine(s) 604 may record the current time (e.g., as determined by a clock) as the “access time,” i.e., the time at which the newly-detected activity/action was initiated. As explained below, the activity/action monitoring service 612 may subsequently record the access time that is so determined as an “access time” entry 1108 for the activity/action in the table 1100.

At a decision step 706 of the routine 700, the activity/action monitoring engine(s) 604 may detect a “switch-out event” for the activity or action for which the switch-in event was detected at the decision step 702. In some implementations, certain detected user interactions with the resource access application 522 and/or a web browser may be considered indicative of a user ceasing to engage in the activity/action for which the switch-in event was detected at the decision step 702. For example, in some implementations, an activity/action monitoring engine 604 for the resource access application 522 may determine that an activity/action switch-out event has taken place when a user 524 (A) clicks on or otherwise selects an action element 548 within a notification 546 so as to cause a corresponding microapp to perform a particular task, (B) dismisses or closes a user interface window for a microapp associated with the activity/action, (C) dismisses or closes a notification 546 associated with the activity/action, (D) clicks on or otherwise selects an action element 548 within a notification 546 associated with a different activity/action so as to cause a microapp associated with the other notification to perform a particular task, (E) clicks on a notification 546 associated with a different activity/action to reveal a user interface window for a microapp associated with the other notification 546, and/or (F) clicks on or otherwise selects a link (e.g., one of the links 103a-e shown in FIG. 1A) for a different action to reveal a user interface window for a microapp associated with the other action.

Additionally or alternatively, in some implementations, an activity/action monitoring engine 604 for a web browser may determine that an activity/action switch-out event has taken place when a user 524 (A) closes the SaaS application associated with the activity/action, (B) closes a particular page of a SaaS application associated with the activity/action, (C) clicks on a link or otherwise causes the web browser to submit particular types of content (e.g., certain forms) to a SaaS application, and/or (D) otherwise takes an action that causes the browser to leave a particular page associated with the activity/action. As indicated, the routine 700 may proceed to a step 708 when such activity/action switch-out event is detected.

At the step 708 of the routine 700, the activity/action monitoring engine(s) 604 may record the current time (e.g., as determined by a clock) as the “leave time,” i.e., the time at which the user ceased engaging in the activity/action for which the switch-in event was detected at the decision step 702. It should be appreciated that, for certain activities/actions, the leave time may be the same as the access time. For example, in circumstances in which the user clicks on or otherwise selects an action element 548 within a notification 546 so as to cause a corresponding microapp to perform a particular task, the switch-in event and the switch-out event for that activity/action may be simultaneous since the user is effectively beginning and ending the same activity/action with a single command. As explained below, the activity/action monitoring service 612 may subsequently record the leave time that is so determined as a “leave time” entry 1110 for the activity/action in the table 1100.

At a step 710, the activity/action monitoring engine(s) 604 may request the context determination engine 606 to determine context data about the client device 202 at the time the switch-out event was detected at the decision step 706. An example routine 800 that may be employed by the context determination engine 606, as well as examples of context data that be determined by that engine, are described below in connection with FIG. 8.

At a decision step 712, the activity/action monitoring engine(s) 604 may determine whether the requested context data has been received from the context determination engine 606. As indicated, the routine 700 may proceed to a decision step 714 when the requested context data has been received.

The example routine 800 that may be performed by the context determination engine 606 will now be described, with reference to FIG. 8, before describing the remainder of the routine 700. Pursuant to the routine 800, the context determination engine 606 may determine context data concerning the client device 202 at a particular time, such as when a switch-out event is detected at the decision step 706 of the routine 700.

As shown in FIG. 8, at a decision step 802 of the routine 800, the context determination engine 606 may determine whether a request for context data has been received from another component, such as the activity/action monitoring engine(s) 604 (as described above) or the recommended action presentation engine 608 (as described below). As indicated, the routine 800 may proceed to a step 804 when such a request is received.

At the step 804, the context determination engine 606 may determine a user ID for the user who is currently operating the client device 202. For example, in some implementations, the user ID may be the user name that the user 524 entered to gain access to resource access application 522. In other implementations, the user ID may be an identification number, separate from such a user name, that is assigned to identify a particular user 524 of the system 100. Since the system 100 may determine next action recommendations on a user-by-user basis, determining user IDs may allow the system 100 to attribute particular activities/actions to specific users 524.

At the step 806 of the routine 800, the context determination engine 606 may determine a device ID of the client device 202 used to engage in the activity/action. As some users 524 engage in activities/actions using multiple different client devices 202, e.g., a smartphone, a laptop computer, a desktop computer, etc., the device ID may be used to differentiate amongst activities/actions engaged in by different types of client devices 202.

At the step 808, the context determination engine 606 may determine the current time of the day, e.g., by recording a value of a clock maintained by the client device 202. In some implementations, the current time of day recorded by the context determination engine 606 may be the same as, and/or may be based at least in part on, the leave time determined by the activity/action monitoring engine 604, or vice versa.

At the step 810, the context determination engine 606 may determine the current day of the week (i.e., Sunday, Monday, etc.), e.g., based on a calendar maintained by the client device 202.

At the step 812, the context determination engine 606 may determine a network ID of the network, if any, to which the client device 202 is currently connected. In some implementations, the network IDs may include the names and/or identifiers of specific networks to which client devices 202 are connected. In other implementations, the network IDs may additionally or alternatively indicate particular types of networks, such as 3G, 4G, 5G, wired local area network (LAN), wireless LAN, etc., to which such devices are connected.

At the step 814 of the routine 800, the context determination engine 606 may determine the current location of the client device 202. For example, the client device 202 may obtain the current coordinates (e.g., latitude and longitude) from a global positioning system (GPS) chip or other location determination device or system.

At the step 816, the context determination engine 606 may send the context data gathered per the steps 804, 806, 808, 810, 812 and 814 to the component that requested it, e.g., the activity/action monitoring engine(s) 604 (as described above) or the recommended action presentation engine 608 (as described below).

Referring again to FIG. 7, at the decision step 714 of the routine 700, the activity/action monitoring engine(s) 604 may determine whether the activity/action for which the switch-in event was detected at the decision step 702 involved a microapp. In some implementations, for example, the activity/action switch-in events that relate to the selection of notifications 546, the selection of action elements 548 within notifications 546, and/or the revealing of a user interface window for a microapp may be deemed to be microapp-based activities/actions.

When, at the decision step 714, the activity/action monitoring engine(s) 604 determine that the activity/action switch-in event detected at the decision step 702 relates to a microapp, the activity/action monitoring engine(s) 604 may, at a step 716, set a “microapp flag” to “true.” When, on the other hand, the activity/action monitoring engine(s) 604 determine that the activity/action switch-in event detected at the decision step 702 does not relate to a microapp, the activity/action monitoring engine(s) 604 may, at a step 718, instead set the microapp flag to “false.” As explained below, the microapp flag (set per the steps 714-718) may be used by the recommended action determination service 618 to distinguish between microapp-based actions and macroapp-based actions for various purposes. For example, in some implementations, the use of the microapp flags may allow the recommended action determination service 618 to identify one or more actions to recommend to a user 524 after the user 524 has engaged in an activity involving a particular microapp when the system 100 has not yet accumulated sufficient data concerning the user's typical next actions following use of that microapp. In particular, as described in more detail below, the recommended action determination service 618 may map the microapp-based activity in which the user is currently engaged to a corresponding macroapp-based activity (e.g., a corresponding task performed using a SaaS application), and may identify one or more next actions the user is likely to take following performance of that macroapp-based activity rather than the microapp-based activity in which the user is actually engaged. Those identified next actions may then be used to generate the recommended actions list 102 for presentation to the user 524 based on the user's current engagement in the microapp activity. As also explained in more detail below, in some implementations, the recommended action determination service 618 may further map some or all of the identified next actions that are not flagged as microapps to corresponding microapp-based actions, and may additionally or alternatively present those corresponding microapp-based actions to the user in the recommended actions list 102, or otherwise.

At a step 718 of the routine 700, the activity/action monitoring engine(s) 604 may determine an identifier of the application (e.g., a system of record 526) to which the activity/action relates. In some implementations, the “app ID” that is so determined may simply be a name of the application (e.g., “Salesforce”). In other implementations, another type of identifier (e.g., a numeric string) identifying the application within the system 100 may be used. For microapp-based activities/actions, the app ID may identify the system of record 526 with which the microapp is configured to interact. For macroapp-based activities/actions, on the other hand, the app ID may identify the application (e.g., a SaaS application) with which the user has interacted directly using the web browser.

At a step 720 of the routine 700, the activity/action monitoring engine(s) 604 may determine an identifier of the type of the activity/action for which data is being collected. In some implementations, for example, respective systems of record 526 may enable users to perform various different types of activities/actions, such as “View My Time Off” and “Request PTO” activity/action types within Workaday, or “Issue Report” and “Approve Expense Report” activity/action types within SAP Concur, etc. As noted previously, in some implementations, the user 524 may engage in such activity/action types either indirectly, e.g., via a microapp that interfaces with a system of record 526, or directly, e.g., by interacting directly with the system of record 526, e.g., via a SaaS application. In some implementations, the activity/action type IDs that are so determined may identify the types of activity/actions that are enabled by the systems of record 526, regardless of whether they are engaged in directly or indirectly. In some implementations, such activity/action type IDs may simply be the names of such activity/action types. In other implementations, another type of identifier (e.g., a numeric string) identifying the particular type of activity/action within the system 100 may be used.

At the step 722 of the routine 700, the activity/action monitoring engine(s) 604 may store a record locally on the client device 202, e.g., in the storage medium(s) 610 shown in FIG. 6, for the detected activity/action. Such a record may include some or all of the data determined by the activity/action monitoring engine(s) 604 and/or the context determination engine 606, as discussed above, including, for example, the app ID, the activity/action type ID, the microapp flag, the access time, the leave time, the user ID, the device ID, the current time, the network ID, location coordinates (e.g., latitude and longitude), etc.

FIG. 9 shows an example routine 900 that may be performed by the activity/action data upload engine 602 shown in FIG. 6. As shown, the routine 900 may begin at a decision step 902, at which the activity/action data upload engine 602 may determine whether a particular period of time, e.g., twenty-four hours, has elapsed since it last uploaded activity/action records to the activity/action monitoring service 612 (shown in FIG. 6). As indicated, the routine 900 may proceed to a decision step 904 when more than the threshold period of time has elapsed.

At the decision step 904, the activity/action data upload engine 602 may evaluate the current load on the client device 202, such as by determining processing capacity and/or available network bandwidth of the client device 202. As indicated, in some implementations, the activity/action data upload engine 602 may wait until the load is low, e.g., below a threshold, before proceeding to a step 906, at which it may send the new activity/event records it has accumulated (since the last time the routine 900 was performed by the client device 202) to the activity/action monitoring service 612.

FIG. 10 shows an example routine 1000 that may be performed by the activity/action monitoring service 612 shown in FIG. 6. As shown, the routine 1000 may begin at a decision step 1002, at which the activity/action monitoring service 612 may determine whether any new activity/action records have been received from the activity/action data upload engine 602 of client device 202. As indicated, the routine 1000 may proceed to a step 1004, upon receipt of one or more such new activity/action records. At the step 1004, the activity/action monitoring service 612 may upload the newly-received activity/event records to the storage medium(s) 104, e.g., to a database table, as described below.

FIG. 11 shows an example table 1100 that the activity/action monitoring service 612 may populate with activity/action data that is received from activity/action data upload engine(s) 602 of one or more client devices 202. In illustrated example, different rows of the table 1100 represent respective activity/action records. As shown, the table 1100 may correlate the activity/action records by user ID (per “user ID” entries 1102), and may include “current activity data” entries 1104, “actionable?” entries 1106, “access time” entries 1108, “leave time” entries 1110, “context data” entries 1112, “context tag” entries 1114, “switch interval” entries 1116, “next action data” entries 1118, and “next action recommendation flag” entries 1120. As indicated, the “current activity data” entries 1104 may comprise several sub-entries, including “app ID” sub-entries 1104a, “activity/action type ID” sub-entries 1104b, and “microapp flag” sub-entries 1104c. Similarly, the “next action data” entries 1118 may comprise several sub-entries, including “app ID” sub-entries 1118a, “activity/action type ID” sub-entries 1118b, and “microapp flag” sub-entries 1118c. Further, as illustrated, the “context data” entries 1112 may also comprise several sub-entries, including “device ID” sub-entries 1112a, “time of day” sub-entries 1112b, “day of week” sub-entries 1112c, “network ID” sub-entries 1112d, and “location sub-entries” 1112e.

Several of the fields in the table 1100 may be populated with the data the activity/action monitoring service 612 receives from one or more activity/action data upload engine(s) 602. Certain of the fields, however, may not be represented in the activity/action data received from the activity/action data upload engine 602 and may instead be subsequently determined by the activity/action monitoring service 612 and/or the next action forecasting service 616. In particular, as explained in more detail below, in some implementations, the activity/action monitoring service 612 and/or the next action forecasting service 616 may be responsible for determining and/or updating the “actionable?” entries 1104, the “context tag” entries 1114, the “switch interval” entries 1116, the “next action data” entries 1118, and the “next action recommendation flag” entries 1120).

FIG. 12 shows an example routine 1200 that may be performed by the context classifier training service 614 shown in FIG. 6. As shown, the routine 1200 may begin at a decision step 1202, at which the context classifier training service 614 may determine whether a particular period of time, e.g., twenty days, has elapsed since it last re-trained a predictive model 124 for a user 524 using context data (e.g., per “context data” entries 1112) of accumulated activity/action records for that user 524. As indicated, the routine 1200 may proceed to a step 1204 when it determines that the period of time has elapsed.

At the step 1204 of the routine 1200, the context classifier training service 614 may select a subset of the accumulated activity/action records to use for re-training the user's predictive model 124. In some implementations, for example, the context classifier training service 614 may select the user's activity/action records (e.g., as stored in the table 1100) for the prior twenty days for such purpose. At a step 1206 of the routine 1200, the context classifier training service 614 may use the records selected at the step 1204 to retrain the predictive model 124 for the user 524.

FIG. 13 shows an example technique that the context classifier training service 614 may use to train and/or update a user's predictive model 124 (per the step 1206 of the routine 1200), as well as the manner in which the trained predictive model 124 may subsequently be used (e.g., by the next action forecasting service 616 and/or the recommended action determination service 618) to determine context tags 128 for particular sets of context data, as described further below.

As FIG. 13 illustrates, the context data from the selected activity/action records (e.g., per the “context data” entries 1112 in the table 1100) may be used as training data 1302 for the machine learning process 120. More specifically, in some implementations, for each of the selected activity/action records, one or more encoders 1304 may encode the various pieces of context data from that record into a feature vector 1306a, 1306b, 1306n, so that a total of “n” feature vectors are generated for a set of “n” selected activity/action records. In some implementations, the different pieces of context data (e.g., the device ID, the time of day, the day of the week, the network ID, the location, etc.) may be identified as separate “features” of a feature vector 1306, such that, for each feature vector 1306, the respective feature values represent different dimensions in a multi-dimensional space. Accordingly, each of the feature vectors 1306a, 1306b, 1306n, etc., may represent a single point in the multi-dimensional space.

As shown in FIG. 13, the feature vectors 1306a, 1306b, 1306n may be provided to the machine learning process 120, and the results of the machine learning process 120 may, in turn, be used train the predictive model 124. In some implementations, the machine learning process 120 may employ an unsupervised learning process to train the predictive model 124. For example, in some implementations, the machine learning process 120 may use a clustering technique to identify a set of “clusters” within the multi-dimensional space for the feature vectors 1306. Examples of suitable data clustering processes included K-means clustering and density-based spatial clustering of applications with noise (DBSCAN). Any of a number of other data clustering techniques, such as mean-shift clustering, expectation-maximum (EM) clustering using Gaussian mixture models (GMM), and k-nearest neighbor (KNN) classification, may additionally or alternatively be employed in some implementations.

After identifying clusters of data points within the multi-dimensional feature space, the machine learning process 120 may train the predictive model 124 to classify a given feature vector 1306x into one of the clusters the machine learning process 120 identified. As explained below, in some implementations, a set of context data (e.g., either from an activity/action record in the table 1100 or from a request for a recommended actions list 102 received from the recommended action presentation engine 608) may be provided as new data 1308 to one or more encoders 1310 (which may be the same as, or operate in the same manner as, the encoder(s) 1304). As shown in FIG. 13, the encoder(s) 1310 may encode the received context data into the feature vector 1306x, and may provide the feature vector 1306x to the predictive model 124 for evaluation. As indicated, the predictive model may then output a cluster ID 1312 identifying the previously-identified cluster into which it has classified the context data (i.e., the new data 1308). As explained in more detail below, the cluster ID 1312 output by the predictive model 124 may be used either as the context tag 128 that is written to the table 1100 (e.g., a “context tag” entry 1114) or as the context tag 128 that is used by the recommended action determination service 618 to identify contextually-relevant next actions to include in a recommended actions list 102, as explained below.

FIG. 14A shows an example routine 1400 that may be performed by the next action forecasting service 616 shown in FIG. 6. FIG. 14B shows an example implementation of a step/routine 1406 of the routine 1400. As shown in FIG. 14A, the routine 1400 may begin at a decision step 1402, at which the next action forecasting service 616 may determine whether a particular period of time, e.g., twenty-four hours, has elapsed since it last updated the next action forecast scores in the table 1500 (see “score” entries 1510—shown in FIG. 15). As indicated, the routine 1400 may proceed to a step 1404 when it determines that the period of time has elapsed.

At a step 1404 of the routine 1400, the next action forecasting service 616 may determine the activity/action records (e.g., from the table 1100) that are to be used to determine/update the next action forecast stores for the table 1500. In some implementations, for example, the next action forecasting service 616 may identify the activity/action records in the table 1100 that were generated less than a threshold period of time (e.g., 20 days) in the past. The “leave time” entries 1110 in the table 1100 may, for example, be used for that purpose. In some implementations, the threshold time period used to select activity/action records at the step 1404 may be the same as the threshold time period that is used to determine (at the decision step 1202 of the routine 1200—shown in FIG. 12) whether to update the predictive model 124. In other implementations, different threshold time periods may be used for those two purposes.

During the step/routine 1406 of the routine 1400, the next action forecasting service 616 may determine and/or update various entries in the table 1100. In some implementations, for example, the next action forecasting service 616 may determine/update the “actionable?” entries 1106, the “context tag” entries 1114, the “switch interval” entries 1116, the “next action data” entries 1118, and the “next action recommendation flag” entries 1120 for the activity/action records selected at the step 1404.

The example implementation of the step/routine 1406 shown in FIG. 14B will now be described, before describing the remainder of the routine 1400 shown in FIG. 14A. As shown in FIG. 14B, per a step 1410 and a decision step 1428 of the step/routine 1406, the next action forecasting service 616 may cycle through the activity/action records selected at the step 1404 to update the above noted entries for those records. Although the example step/routine 1406 indicates that the entries for such records are updated in series, i.e., one at a time, it should be appreciated that they may alternatively be updated, in whole or in part, in parallel.

At a step 1412 of the step/routine 1406, the next action forecasting service 616 may determine and/or update the “context tag” entry 1114 in the table 1100 for the selected activity/action record. With reference to FIGS. 11 and 13, to update a given context tag 128 for an activity/action record, the encoder(s) 1310 may be used to encode the stored context data for the record, e.g., the context data entries 1112a-e, into a feature vector 1306x, and may provide that feature vector 1306x to the predictive model 124 for processing. As explained above, because of how the predictive model 124 was trained (using the machine learning process 120), the predictive model 124 may output a cluster ID 1312 that may be used as the (new or updated) context tag 128 for the activity/action record under consideration. The context tag 128 that is so determined may be entered into the table 1100 as a new and/or updated “context tag” entry 1114 for the selected activity/action record.

At a step 1414 of the step/routine 1406, the next action forecasting service 616 may determine and/or update the “next action data” entry 1118 in the table 1100 for the selected activity/action record. In some implementations, for example, the next action forecasting service 616 may examine the activity/action records selected at the step 1404 to identify the activity/action record for which the value of the “access time” entry 1108 is closest in time to the value of the “leave time” entry 1110 for the activity/action record under consideration. In some implementations, the values of the “activity/action data” sub-entries 1104a-c for the identified activity/action records may then be included as “next action data” sub-entries 1118a-c in the table 1100. In other implementations, the “next action data” entry 1118 may alternatively or additionally include a reference to the identified activity/action record and/or the “activity/action data” sub-entries 1104a-c for that record.

At a step 1416 of the step/routine 1406, the next action forecasting service 616 may determine and/or update the “switch interval” entry 1116 in the table 1100 for the selected activity/action record. In some implementations, the next action forecasting service 616 may calculate the value for the “switch interval” entry 1116 by calculating the time difference between the value of the “access time” entry 1108 of the activity/action record for the next action identified at the step 1414 and the value of the “leave time” entry 1110 for the activity/action record selected at the step 1410. That calculated time difference may then be entered into the table 1100 as a new and/or updated “switch interval” entry 1116 for the selected activity/action record.

Pursuant to decision steps 1418, 1420, and 1422 of the step/routine 1406, the next action forecasting service 616 may determine whether to set the “next action recommendation flag” entry 1120 in the table 1100 for the activity/action record under consideration to “true” or “false.” As explained below, when the “next action recommendation flag” entry 1120 is “true,” the activity/action record may be considered when calculating next action forecast scores to include in the table 1500, as described below. On the other hand, when the “next action recommendation flag” entry 1120 is “false,” the activity/action record may be excluded from consideration when calculating such scores.

More specifically, at the decision step 1418, the next action forecasting service 616 may determine whether the switch interval determined/updated at the step 1416 is greater than a threshold time period, e.g., ten minutes. When, at the decision step 1418, the next action forecasting service 616 determines that the switch interval exceeds the threshold time period, the step/routine 1406 may proceed to a step 1424, at which the next action forecasting service 616 may write the “next action recommendation flag” entry 1120 to “false.” The use of a threshold time period as a gating factor in this way may prevent the next action forecasting service 616 from generating forecast scores based on activity/action sequences that are unlikely to be logically related because of the amount of time that elapses between when the user engages in an activity and subsequently takes an action. When, on the other hand, the next action forecasting service 616 determines (at the decision step 1418) that the switch interval does not exceed the threshold time period, the step/routine 1406 may instead proceed to the decision step 1420.

At the decision step 1420, the next action forecasting service 616 may determine whether the activity/action indicated by the “next action data” entry 1118 is “actionable.” An activity/action may be considered “actionable” when, for example, a microapp has been configured to perform the activity/action or when the system is otherwise configured to present a user interface element that allows the user to seamlessly perform the activity/action, such as by directing a web browser to a page of a SaaS application from which the activity/action may be taken. In some implementations, the system 100 may maintain records indicating combinations of app IDs, activity/action type IDs, and microapp flags that correspond to “actionable” activities/actions, and, at the decision step 1420, next action forecasting service 616 may determine whether the combination the sub-entries 1118a-c for the activity/action record being evaluated is included in those records.

When, at the decision step 1420, the next action forecasting service 616 determines that the activity/action indicated by the “next action data” entry 1118 is not actionable, the step/routine 1406 may proceed to the step 1424, at which the next action forecasting service 616 may write the “next action recommendation flag” entry 1120 to “false.” Making sure that the activities/actions indicated by the “next action data” entries 1118 are actionable in this way may prevent the next action forecasting service 616 from generating forecast scores for activities/actions the system 100 is not configured to make available via the recommended actions list 102. When, on the other hand, the next action forecasting service 616 determines (at the decision step 1420) that the activity/action indicated by the “next action data” entry 1118 is actionable, the step/routine 1406 may instead proceed to the decision step 1422.

At the decision step 1422, the next action forecasting service 616 may determine whether the activity/action record for the activity/action indicated by the “next action data” entry 1118 has the same context tag as the activity/action record under consideration. The next action forecasting service 616 may make such a determination, for example, by comparing the values of the “context tag” entries 1114 for the two activity/action records.

When, at the decision step 1422, the next action forecasting service 616 determines that the activity/action record for the activity/action indicated by the “next action data” entry 1118 does not have the same context tag as the activity/action record under consideration, the step/routine 1406 may proceed to the step 1424, at which the next action forecasting service 616 may write the “next action recommendation flag” entry 1120 to “false.” Making sure that the activity/action records have the same context tags may help improve the accuracy of the next action recommendations the system 100 provides, by focusing on activity/action sequences that occur in similar contextual scenarios, e.g., using a desktop computer in the office on a workday, using a mobile device at home on a weekend, etc. When, on the other hand, the next action forecasting service 616 determines (at the decision step 1422) that the activity/action record for the activity/action indicated by the “next action data” entry 1118 does have the same context tag as the activity/action record under consideration, the step/routine 1406 may instead proceed to the step 1426, at which the next action forecasting service 616 may write the “next action recommendation flag” entry 1120 to “true.”

As noted previously, per the decision step 1428, the step/routine 1406 may be repeated until all of the activity/action records selected at the step 1404 have been processed.

Referring again to FIG. 14A, at a step 1408 of the routine 1400, the next action forecasting service 616 may generate and/or update the table 1500 of next action forecast scores using the activity/action records that were selected at the step 1404 and for which the “next action recommendation flag” entries 1120 are “true.” In the illustrated example, the table 1500 shows a set of determined next action forecast scores (as indicated by the “score” entries 1510 for the user “U1” (as indicated by the “user ID” entries 1502). As shown, the table 1500 may include a next action forecast score for respective combinations of “current activity data” entries 1504, “context tag” entries 1506, and “next action data” entries 1508.

In some implementations, the respective next action forecast scores may simply reflect, for the data set being considered, the total number of activity/action records that include (in the table 1100) the indicated combination of “current activity data” entries 1104, “context tag” entries 1114, and “next action data” entries 1118 and for which for which the “next action recommendation flag” entries 1120 are “true.”

For example, entry 1512 in the table 1500 may reflect that, in the activity/action records under consideration, a total of “22” such records had a “next action recommendation flag” entry 1120 that was “true” and also indicated that the user transitioned from an activity identified by a “current activity data” entry 1104 having a value of “CA1” to an action identified by a “next action data” entry 1118 having a value “NA1” while in a contextual scenario identified by a “context tag” entry 1114 with a value “C1.” In other implementations, different weights may be applied to different activity/action records when determining the next action forecast scores in the table 1500. For example, if records for the last “X” days are being evaluated, lower weights may be applied to older records, so that the more recent records influence the next action forecast scores more than the less recent ones. In some implementations, for example, an exponential moving average (e.g., a first-order infinite response filter that applies weighting factors that decrease exponentially) may be applied to weight the different activity/action records differently.

FIG. 16 shows an example routine 1600 that may be performed by the recommended action presentation engine 608 shown in FIG. 6. As noted previously, the recommended action presentation engine 608 may be located on a client device 202, e.g., as a component of the resource access application 522 shown in FIG. 5C. As shown, the routine 1600 may begin at a decision step 1602, at which the recommended action presentation engine 608 may determine whether a new microapp-based activity has been detected. In some implementations, such a new microapp-based activity may, for example, correspond to a user 524 (A) clicking on or otherwise selecting an action element 548 within a notification 546 so as to cause a corresponding microapp to perform a particular task, (B) clicking on or otherwise selecting a notification 546 to reveal a user interface window for a microapp associated with the notification 546, and/or (C) clicking on or otherwise selecting a link (e.g., one of the links 103a-e shown in FIG. 1A) to reveal a user interface window for a microapp. As indicated, the routine 1600 may proceed to a step 1604 when the recommended action presentation engine 608 determines that such a new microapp-based activity has been detected.

At the step 1604, the recommended action presentation engine 608 may request the current context data from the context determination engine 606 (shown in FIG. 6). The manner in which the context determination engine 606 may determine such context data, as well as examples of the context data that may be so determined, are described above in connection with FIG. 8. In some implementations, the items of context data that the context determination engine 606 determines in response to requests from the recommended action presentation engine 608 may be the same as those that are determined in response to requests by the activity/action monitoring engine(s) 604, as described above. For example, similar to the context data that the context determination engine 606 accumulated during the notification access monitoring process discussed above, examples of context data that may gathered by the context determination engine 606 in response to the request per the step 1604 include (A) a device ID identifying the client device 202, (B) the current time of day, (C) the current day of the week, (D) a network ID identifying the network to which the client device 202 is currently connected, and (E) a current location (e.g., latitude and longitude) of the client device 202.

Per a decision step 1606, the routine 1600 may proceed to a step 1608 after the context data has been received from the context determination engine 606 in response to the request sent at the step 1604.

At the step 1608 of the routine 1600, the recommended action presentation engine 608 may send a request for recommended next actions to the recommended action determination service 618 (shown in FIG. 6). As indicated, that request may include an indication of the current activity (e.g., the microapp-based activity detected at the decision step 1602) and the context data that was received from the context determination engine (per the decision step 1606).

At a decision step 1610, the recommended action presentation engine 608 may determine whether data identifying the requested recommended next actions has been received from the recommended action determination service 618. As indicated, the routine 1600 may proceed to a step 1612 when data identifying the requested recommended next actions has been received.

At the step 1612 of the routine 1600, the recommended action presentation engine 608 may cause the client device 202 to present the recommended actions list 102 (shown in FIG. 1A) such that the list 102 includes the recommended next actions identified in the data received from the recommended action determination service 618.

FIG. 17 shows an example routine 1700 that may be performed by the recommended action determination service 618 shown in FIG. 6. As shown, the routine 1700 may begin at a decision step 1702, at which the recommended action determination service 618 may determine whether a request for request for recommended next actions has been received from a client device 202. Such a request may, for example, correspond to the request sent by the recommended action presentation engine 608 pursuant to the step 1608 of the routine 1600 (shown in FIG. 16). As indicated, the routine 1700 may proceed to a step 1704 when the recommended action determination service 618 receives such a request. As noted above, such a request for recommended next actions may include an indication of the activity in which the user 524 is currently engaged (e.g., the microapp-based activity detected at the decision step 1602 of the routine 1600) and the context data that the recommended action presentation engine 608 received from the context determination engine 606 (per the decision step 1610 of the routine 1600).

At the step 1704 of the routine 1700, the recommended action determination service 618 may use the predictive model 124 (shown in FIGS. 1B and 13) to determine a context tag 128 for the context data that was included in the request. As explained above in connection with FIG. 13, the recommended action determination service 618 may, for example, use the encoder(s) 1310 to encode the received context data into a context feature vector 1306x, and may provide that context feature vector 1306x to the predictive model 124 for determination of a cluster ID 1312 that can be used as the context tag 128 for the context data that was included in the request.

At a decision step 1706a of the routine 1700, the recommended action determination service 618 may determine whether the system 100 is in a “cold start phase” for the user 524. As FIG. 17 shows, the same (or similar) decision step 1706b may also be performed a second time later in the routine 1700. The system 100 may be determined to be in a cold start phase for a given user when, for example, the table 1100 includes an insufficient amount of recent historical data indicative of that user's past activity/action sequences involving microapps to generate meaningful predictions concerning the user's likely next actions after engaging in particular microapp-based activities. The table 1100 may lack such recent historical data for a user when, for instance, the user only recently began using the system 100 (e.g., a new employee) or the user has ceased using the system 100 for an extended period of time (e.g., an employee who has taken a leave of absence).

The recommended action determination service 618 may determine whether the system 100 is in a cold start phase for the user 524 in any of a number of ways. In some implementations, for example, the recommended action determination service 618 may determine (at the decision step 1706) whether the table 1100 has more than a threshold number (e.g., “50”) of “microapp flag” sub-entries 1104c (as a part of “current activity data” entries 1104) for the user 524 that have been set to “true” and for which the “leave time” entries 1110 indicate the corresponding activities were engaged in less than a threshold period of time in the past. In some implementations, for example, the threshold time period used for such a determination may be the same time period (e.g., “20” days) that is used by the next action forecasting service 616 (per the step 1404 of the routine 1400—shown in FIG. 14) to select activity/action records for the purpose of determining/updating next action forecast scores. In other implementations, the recommended action determination service 618 may determine whether the system 100 is in a cold start phase for the user 524 by additionally or alternatively evaluating the data in the table 1500 for the user 524 to determine whether it contains more than a threshold number of “microapp flag” sub-entries 1504c (as a part of “current activity data” entries 1504) for the user 524 that have been set to “true” and/or whether the cumulative value of the next action forecast scores (per “score” entries 1510) associated with “microapp flag” sub-entries 1504c that have been set to “true” exceeds a threshold value (e.g., “50”).

When, at the decision step 1706a, the recommended action determination service 618 determines that the system 100 is in a cold start phase for the user 524, the routine 1700 may proceed to a step 1708, at which the recommended action determination service 618 may determine a macroapp-based activity (e.g., an activity a user can perform by interacting directly with a SaaS application) that corresponds to the microapp-based activity indicated in the request that was received at the decision step 1702. When, on the other hand, the recommended action determination service 618 determines (at the decision step 1706a) that the system 100 is not in a cold start phase for the user 524, the routine 1700 may instead proceed to a step 1710 (which is described further below).

As noted above, in some implementations, a microapp may be configured to engage in a particular activity/action with respect to a system of record 526 on behalf of user 524, so that user need not directly access and interact with system of record (e.g., by launching and interacting with a SaaS application) to engage in the activity/action. In some implementations, when a new microapp is created to perform a particular activity/action (i.e., a microapp-based activity/action), that microapp-based activity/action may be mapped to the macroapp-based activity/action that the microapp is configured to perform. In some implementations, such a microapp-based activity/action and its corresponding macroapp-based activity/action may be assigned the same “app ID” to designate the system of record 526 to which it relates, and may also be assigned the same “activity/action type ID” to designate the particular activity/action to be performed with respect to that system of record 526. Those assigned app IDs and activity/action type IDs may be the values that are written as the “app ID” entries 1104a and the “activity/action type ID” entries 1104b, respectively, in the table 1100 (shown in FIG. 11).

Whether the particular activity/action is microapp-based or macroapp-based may be indicated, for example, by the corresponding “microapp flag” sub-entries 1104c in table 1100. Accordingly, in some implementations, the step 1708 of the routine 1700 may involve electing to use a “false” value for the microapp flag, rather than a “true” value, when comparing the current activity data received from the recommended action presentation engine 608 against the entries in the table 1500 (as described below) to identify one or more recommended next actions for the user 524. In other words, when the recommended action determination service 618 determines (at the decision step 1706a) that the system 100 is in cold start phase, even though the user is actually involved in a microapp-based version of an activity, the recommended action determination service 618 may determine one or more recommended next actions based on the user's historical activity/action sequences involving transitions from the macroapp-based version of that same activity.

At a step 1710 of the routine 1700, the recommended action determination service 618 may evaluate the data for the user 524 in the table 1500 (shown in FIG. 15), e.g., by referencing the “user ID” entries 1502, to select one or more recommended next actions based on the next action forecast scores (per the “score” entries 1510). In particular, in some implementations, the recommended action determination service 618 may identify the rows in the table 1500 for which (A) the “user ID” entry 1502 corresponds to the user currently operating the client device 202, (B) the value of the “current activity data” entry 1504 matches the current activity data that was sent by the recommended action presentation engine 608 (per the step 1608 of the routine 1600—shown in FIG. 16), and possibly comparing a “false” value rather than a “true” value against the “microapp flag” sub-entry 1504c for a cold start phase scenario, as discussed above, and (C) the “context tag” entry 1506 is the same as the context tag that was determined at the step 1704 based on the current context data that was sent by the recommended action presentation engine 608 (per the step 1608 of the routine 1600—shown in FIG. 16). After identifying such rows, the recommended action determination service 618 may determine that the actions indicated by the “next action data” entries 1508 in those rows are available for selection as recommended next actions. In some implementations, the recommended action determination service 618 may refrain from identifying next actions for which the next action forecast score (per a “score” entry 1510) is below a threshold value (e.g., “2”), so as to filter out data concerning atypical activity/action sequences that might be reflected in the user's historical data.

At a decision step 1712 of the routine 1700, the recommended action determination service 618 may determine whether “N” or more recommended next actions were identified at the step 1710.

When, at the decision step 1712, the recommended action determination service 618 determines that the number of recommended next actions identified at the step 1710 is greater than or equal to “N,” the routine 1700 may proceed to a step 1714, at which the recommended action determination service 618 may select the top “N” recommended actions based on the next action forecast scores. In some implementations, for example, a set of “N” recommended next actions having the highest forecast scores may be selected for inclusion of the recommended actions list 102 (shown in FIG. 1A). When, on the other hand, the recommended action determination service 618 determines (at the decision step 1717) that fewer than “N” recommended next actions were identified at the step 1710, the routine 1700 may instead proceed to a step 1716, at which the recommended action determination service 618 may select all of identified next actions as recommended next actions to include on the recommended actions list 102.

At a step 1718 of the routine 1700, the recommended action determination service 618 may, in some implementations, select additional “hot” actions to be include on the recommended actions list 102 so as to bring the total number of recommended actions to “N.” In some implementations, such additional next actions may be selected based on historical activity/action sequence data for other users using a technique similar to that described above. In other implementations, such additional next actions may include one or more recently used or commonly used actions, similar to the actions on the list 554 of recently and/or commonly used microapp actions described above in connection with FIG. 5D.

At a decision step 1706b, the recommended action determination service 618 may again determine whether the system 100 is in a cold start phase for the user 524. As noted previously, the technique used to make that determination may the same as or similar to the technique described above in connection with the decision step 1706a.

When, at the decision step 1706b, the recommended action determination service 618 determines that the system 100 is in a cold start phase for the user 524, the routine 1700 may proceed to a step 1720, at which the recommended action determination service 618 may determine microapp-based actions that correspond to one or more macroapp-based actions selected at the steps 1714, 1716 and/or 1718, to the extent that microapps have been created to perform those actions. The mapping of microapp-based activities/actions to macroapp-based activities/actions discussed above in connection with the step 1708 may be used for this purpose. Following the step 1720, the routine 1700 may proceed to a step 1722, at which the recommended action determination service 618 may send data representing the set of “N” recommended next actions to the recommended action presentation engine 608, so as to cause the client device 202 to display the selected recommended actions to the user 524 in the form of the recommended actions list 102, or otherwise. For those macro-based actions for which the recommended action determination service 618 identified (at the step 1720) corresponding microapp-based actions, the recommended action determination service 618 may include data representing such micro-app based actions, rather than the corresponding macroapp-based actions, in the data it sends to the recommended action presentation engine 608.

When, at the decision step 1706b, the recommended action determination service 618 determines that the system 100 is not in a cold start phase for the user 524, the routine 1700 may instead proceed to directly to the step 1722, at which the recommended action determination service 618 may send data representing the set of “N” recommended next actions to the recommended action presentation engine 608, so as to cause the client device 202 to display the selected recommended actions to the user 524 in the form of the recommended actions list 102, or otherwise.

G. Example Implementations of Methods, Systems, and Computer-Readable Media in Accordance with the Present Disclosure

The following paragraphs (M1) through (M12) describe examples of methods that may be implemented in accordance with the present disclosure.

(M1) A method may involve determining, by a computing system, that a user took a first action with respect to a first system of record after engaging in a first activity relating to a second system of record; determining, by the computing system, that the first activity is of a first activity type; determining, by the computing system, that the first action is of a first action type; determining, by the computing system, that the user has engaged in a second activity of the first activity type; and based at least in part on (A) the user having taken the first action after engaging in the first activity, (B) the first activity being of the first activity type, (C) the first action being of the first action type, and (D) the second activity being of the first activity type, causing a client device to present a first user interface element that is selectable to enable the user to take a second action of the first action type with respect to the second system of record.

(M2) A method may be performed as described in paragraph (M1), wherein the first activity may comprised interaction with a first microapp that is configured to interact with the second system of record; determining that the user is engaged in the second activity of the first activity type may comprise determining that the user has interacted with the first microapp; determining that the user took the first action may comprise determining that the user interacted with a second microapp that is configured to interact with the first system of record; and the first user interface element may be selectable to enable the user to access the second microapp to take the second action.

(M3) A method may be performed as described in paragraph (M1), wherein the first activity may comprise interaction with a first microapp that is configured to interact with the second system of record; determining that the user is engaged in the second activity of the first activity type may comprise determining that the user has interacted with the first microapp; the first system of record may comprise a software-as-a-service (SaaS) application; determining that the user took the first action may comprise determining that the user operated a web browser to interact with the SaaS application to take the first action; and the first user interface element may be selectable to cause the web browser to access the SaaS application to take the second action.

(M4) A method may be performed as described in any of paragraphs (M1) through (M3), and may further involve determining, by the computing system, that the user took the first action when the client device was in a first context; determining, by the computing system, that the client device was in the first context when the user engaged in the second activity; wherein causing the client device to present the first user interface element may be further based at least in part on the first action having been taken when the client device was in the first context and the client device having been in the first context when the user engaged in the second activity.

(M5) A method may be performed as described in paragraph (M4), wherein determining that the user took the first action when the client device was in the first context may further involve determining feature vectors for respective actions the user took with respect to one or more systems of record, the feature vectors representing first context data about one or more client devices at times that respective actions were taken, the feature vectors including a first feature vector for the first action, and determining, using a predictive model configured to classify input feature vectors into context types, that the first feature vector is classified as a first context type, and wherein determining that the client device was in the first context when the user engaged in the second activity may further involve determining a second feature vector representing second context data about the client device when the user the user engaged in the second activity, and determining, using the predictive model, that the second feature vector is classified as the first context type.

(M6) A method may be performed as described in paragraph (M5), and may further involve generating, using at least a first group of the feature vectors and a clustering process, the predictive model.

(M7) A method may be performed as described in paragraph (M1) or any of paragraphs (M4) through (M6), wherein the second system of record may comprise a first software-as-a-service (SaaS) application, the first activity may comprise operation of a web browser to interact with the first SaaS application; determining that the first activity is of the first activity type may comprise mapping a function performed by the first SaaS application in response to the operation of the web browser to a first microapp that is configured to interact with first SaaS application to perform the function; and determining that the user has engaged in the second activity of the first activity type may comprise determining that the user has interacted with the first microapp.

(M8) A method may be performed as described in paragraph (M7), wherein determining that the user took the first action may comprise determining that the user interacted with a second microapp that is configured to interact with the first system of record; and the first user interface element may be selectable to enable the user to access the second microapp to take the second action.

(M9) A method may be performed as described in any of paragraphs (M1) through (M8), wherein determining that the first activity is of the first activity type may comprise determining that the first activity corresponds to a first notification type the computing system is configured to send the user relating to events of the second system of record; and determining that the user has engaged in the second activity of the first activity type may comprise determining that the user has accessed a notification of the first notification type.

(M10) A method may be performed as described in any of paragraphs (M1) through (M9), wherein the first system of record may be different than the second system of record.

(M11) A method may be performed as described in any of paragraphs (M1) through (M9), wherein the first system of record may be the same as the second system of record.

(M12) A method may be performed as described in any of paragraphs (M1) through (M11), and may further involve determining a number of instances in which the user took the first action with respect to the first system of record after engaging in the first activity relating to the second system of record, and calculating a score based on the number of instances; wherein causing the client device to present the first user interface element may be further based at least in part on the score.

The following paragraphs (S1) through (S12) describe examples of systems and devices that may be implemented in accordance with the present disclosure.

(S1) A system may comprise at least one processor, and at least one computer-readable medium encoded with instructions which, when executed by the at least one processor, cause the system to determine that a user took a first action with respect to a first system of record after engaging in a first activity relating to a second system of record, to determine that the first activity is of a first activity type, to determine that the first action is of a first action type, to determine that the user has engaged in a second activity of the first activity type, and based at least in part on (A) the user having taken the first action after engaging in the first activity, (B) the first activity being of the first activity type, (C) the first action being of the first action type, and (D) the second activity being of the first activity type, to cause a client device to present a first user interface element that is selectable to enable the user to take a second action of the first action type with respect to the second system of record.

(S2) A system may be configured as described in paragraph (S1), wherein the first activity may comprises interaction with a first microapp that is configured to interact with the second system of record, and the at least one computer-readable medium may be further encoded with additional instruction which, when executed by the at least one processor, further cause the system to determine the user is engaged in the second activity of the first activity type at least on part by determining that the user has interacted with the first microapp, to determine that the user took the first action at least on part by determining that the user interacted with a second microapp that is configured to interact with the first system of record, and to configure the first user interface element to be selectable to enable the user to access the second microapp to take the second action.

(S3) A system may be configured as described in paragraph (S1), wherein the first activity may comprise interaction with a first microapp that is configured to interact with the second system of record, the first system of record may comprise a software-as-a-service (SaaS) application, and the at least one computer-readable medium may be further encoded with additional instruction which, when executed by the at least one processor, further cause the system to determine that the user is engaged in the second activity of the first activity type at least in part by determining that the user has interacted with the first microapp, to determine that the user took the first action at least in part by determining that the user operated a web browser to interact with the SaaS application to take the first action, and to configure the first user interface element to be selectable to cause the web browser to access the SaaS application to take the second action.

(S4) A system may be configured as described in any of paragraphs (S1) through (S3), and the at least one computer-readable medium may be further encoded with additional instruction which, when executed by the at least one processor, further cause the system to determine that the user took the first action when the client device was in a first context, to determine that the client device was in the first context when the user engaged in the second activity, and to cause the client device to present the first user interface element further based at least in part on the first action having been taken when the client device was in the first context and the client device having been in the first context when the user engaged in the second activity.

(S5) A system may be configured as described in paragraph (S4), wherein the at least one computer-readable medium may be further encoded with additional instruction which, when executed by the at least one processor, further cause the system to determine that the user took the first action when the client device was in the first context at least in part by determining feature vectors for respective actions the user took with respect to one or more systems of record, the feature vectors representing first context data about one or more client devices at times that respective actions were taken, the feature vectors including a first feature vector for the first action, to determine, using a predictive model configured to classify input feature vectors into context types, that the first feature vector is classified as a first context type, to determine that the client device was in the first context when the user engaged in the second activity at least in part by determining a second feature vector representing second context data about the client device when the user the user engaged in the second activity, and to determine, using the predictive model, that the second feature vector is classified as the first context type.

(S6) A system may be configured as described in paragraph (S5), wherein the at least one computer-readable medium may be further encoded with additional instruction which, when executed by the at least one processor, further cause the system to generate, using at least a first group of the feature vectors and a clustering process, the predictive model.

(S7) A system may be configured as described in paragraph (S1) or any of paragraphs (S4) through (S6), wherein the second system of record may comprise a first software-as-a-service (SaaS) application, the first activity may comprise operation of a web browser to interact with the first SaaS application, and the at least one computer-readable medium may be further encoded with additional instruction which, when executed by the at least one processor, further cause the system to determine that the first activity is of the first activity type at least in part by mapping a function performed by the first SaaS application in response to the operation of the web browser to a first microapp that is configured to interact with first SaaS application to perform the function, and to determine that the user has engaged in the second activity of the first activity type at least in part by determining that the user has interacted with the first microapp.

(S8) A system may be configured as described in paragraph (S7), wherein the at least one computer-readable medium may be further encoded with additional instruction which, when executed by the at least one processor, further cause the system to determine that the user took the first action at least in part by determining that the user interacted with a second microapp that is configured to interact with the first system of record, and to configure the first user interface element to be selectable to enable the user to access the second microapp to take the second action.

(S9) A system may be configured as described in any of paragraphs (S1) through (S8), wherein the at least one computer-readable medium may be further encoded with additional instruction which, when executed by the at least one processor, further cause the system to determine that the first activity is of the first activity type at least in part by determining that the first activity corresponds to a first notification type the computing system is configured to send the user relating to events of the second system of record, and to determine that the user has engaged in the second activity of the first activity type at least in part by determining that the user has accessed a notification of the first notification type.

(S10) A system may be configured as described in any of paragraphs (S1) through (S9), wherein the first system of record may be different than the second system of record.

(S11) A system may be configured as described in any of paragraphs (S1) through (S9), wherein the first system of record may be the same as the second system of record.

(S12) A system may be configured as described in any of paragraphs (S1) through (S11), wherein the at least one computer-readable medium may be further encoded with additional instruction which, when executed by the at least one processor, further cause the system to determine a number of instances in which the user took the first action with respect to the first system of record after engaging in the first activity relating to the second system of record, to calculate a score based on the number of instances, and to cause the client device to present the first user interface element further based at least in part on the score.

The following paragraphs (CRM1) through (CRM12) describe examples of computer-readable media that may be implemented in accordance with the present disclosure.

(CRM1) At least one non-transitory computer-readable medium may be encoded with instructions which, when executed by at least one processor included in a computing system, cause the computing system to determine that a user took a first action with respect to a first system of record after engaging in a first activity relating to a second system of record, to determine that the first activity is of a first activity type, to determine that the first action is of a first action type, to determine that the user has engaged in a second activity of the first activity type, and based at least in part on (A) the user having taken the first action after engaging in the first activity, (B) the first activity being of the first activity type, (C) the first action being of the first action type, and (D) the second activity being of the first activity type, to cause a client device to present a first user interface element that is selectable to enable the user to take a second action of the first action type with respect to the second system of record.

(CRM2) At least one non-transitory computer-readable medium may be configured as described in paragraph (CRM1), wherein the first activity may comprises interaction with a first microapp that is configured to interact with the second system of record, and the at least one computer-readable medium may be further encoded with additional instructions which, when executed by the at least one processor, further cause the computing system to determine the user is engaged in the second activity of the first activity type at least on part by determining that the user has interacted with the first microapp, to determine that the user took the first action at least on part by determining that the user interacted with a second microapp that is configured to interact with the first system of record, and to configure the first user interface element to be selectable to enable the user to access the second microapp to take the second action.

(CRM3) At least one non-transitory computer-readable medium may be configured as described in paragraph (CRM1), wherein the first activity may comprise interaction with a first microapp that is configured to interact with the second system of record, the first system of record may comprise a software-as-a-service (SaaS) application, and the at least one computer-readable medium may be further encoded with additional instructions which, when executed by the at least one processor, further cause the computing system to determine that the user is engaged in the second activity of the first activity type at least in part by determining that the user has interacted with the first microapp, to determine that the user took the first action at least in part by determining that the user operated a web browser to interact with the SaaS application to take the first action, and to configure the first user interface element to be selectable to cause the web browser to access the SaaS application to take the second action.

(CRM4) At least one non-transitory computer-readable medium may be configured as described in any of paragraphs (CRM1) through (CRM3), and may be further encoded with additional instructions which, when executed by the at least one processor, further cause the computing system to determine that the user took the first action when the client device was in a first context, to determine that the client device was in the first context when the user engaged in the second activity, and to cause the client device to present the first user interface element further based at least in part on the first action having been taken when the client device was in the first context and the client device having been in the first context when the user engaged in the second activity.

(CRM5) At least one non-transitory computer-readable medium may be configured as described in paragraph (CRM4), and may be further encoded with additional instructions which, when executed by the at least one processor, further cause the computing system to determine that the user took the first action when the client device was in the first context at least in part by determining feature vectors for respective actions the user took with respect to one or more systems of record, the feature vectors representing first context data about one or more client devices at times that respective actions were taken, the feature vectors including a first feature vector for the first action, to determine, using a predictive model configured to classify input feature vectors into context types, that the first feature vector is classified as a first context type, to determine that the client device was in the first context when the user engaged in the second activity at least in part by determining a second feature vector representing second context data about the client device when the user the user engaged in the second activity, and to determine, using the predictive model, that the second feature vector is classified as the first context type.

(CRM6) At least one non-transitory computer-readable medium may be configured as described in paragraph (CRM5), and may be further encoded with additional instructions which, when executed by the at least one processor, further cause the computing system to generate, using at least a first group of the feature vectors and a clustering process, the predictive model.

(CRM7) At least one non-transitory computer-readable medium may be configured as described in paragraph (CRM1) or any of paragraphs (CRM4) through (CRM6), wherein the second system of record may comprise a first software-as-a-service (SaaS) application, the first activity may comprise operation of a web browser to interact with the first SaaS application, and the at least one computer-readable medium may be further encoded with additional instructions which, when executed by the at least one processor, further cause the computing system to determine that the first activity is of the first activity type at least in part by mapping a function performed by the first SaaS application in response to the operation of the web browser to a first microapp that is configured to interact with first SaaS application to perform the function, and to determine that the user has engaged in the second activity of the first activity type at least in part by determining that the user has interacted with the first microapp.

(CRM8) At least one non-transitory computer-readable medium may be configured as described in paragraph (CRM7), and may be further encoded with additional instructions which, when executed by the at least one processor, further cause the computing system to determine that the user took the first action at least in part by determining that the user interacted with a second microapp that is configured to interact with the first system of record, and to configure the first user interface element to be selectable to enable the user to access the second microapp to take the second action.

(CRM9) At least one non-transitory computer-readable medium may be configured as described in any of paragraphs (CRM1) through (CRM8), and may be further encoded with additional instructions which, when executed by the at least one processor, further cause the computing system to determine that the first activity is of the first activity type at least in part by determining that the first activity corresponds to a first notification type the computing system is configured to send the user relating to events of the second system of record, and to determine that the user has engaged in the second activity of the first activity type at least in part by determining that the user has accessed a notification of the first notification type.

(CRM10) At least one non-transitory computer-readable medium may be configured as described in any of paragraphs (CRM1) through (CRM9), wherein the first system of record may be different than the second system of record.

(CRM11) At least one non-transitory computer-readable medium may be configured as described in any of paragraphs (CRM1) through (CRM9), wherein the first system of record may be the same as the second system of record.

(CRM12) At least one non-transitory computer-readable medium may be configured as described in any of paragraphs (CRM1) through (CRM11), and may be further encoded with additional instructions which, when executed by the at least one processor, further cause the computing system to determine a number of instances in which the user took the first action with respect to the first system of record after engaging in the first activity relating to the second system of record, to calculate a score based on the number of instances, and to cause the client device to present the first user interface element further based at least in part on the score.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
determining, by a computing system, that a user took a first action with respect to a first system of record after engaging in a first activity relating to a second system of record;
determining, by the computing system, that the first activity is of a first activity type;
determining, by the computing system, that the first action is of a first action type;
determining, by the computing system, that the user has engaged in a second activity of the first activity type; and
based at least in part on (A) the user having taken the first action after engaging in the first activity, (B) the first activity being of the first activity type, (C) the first action being of the first action type, and (D) the second activity being of the first activity type, causing a client device to present a first user interface element that is selectable to enable the user to take a second action of the first action type with respect to the second system of record.

2. The method of claim 1, wherein:
the first activity comprises interaction with a first microapp that is configured to interact with the second system of record;
determining that the user is engaged in the second activity of the first activity type comprises determining that the user has interacted with the first microapp;
determining that the user took the first action comprises determining that the user interacted with a second microapp that is configured to interact with the first system of record; and
the first user interface element is selectable to enable the user to access the second microapp to take the second action.

3. The method of claim 1, wherein:
the first activity comprises interaction with a first microapp that is configured to interact with the second system of record;
determining that the user is engaged in the second activity of the first activity type comprises determining that the user has interacted with the first microapp;
the first system of record comprises a software-as-a-service (SaaS) application;
determining that the user took the first action comprises determining that the user operated a web browser to interact with the SaaS application to take the first action; and
the first user interface element is selectable to cause the web browser to access the SaaS application to take the second action.

4. The method of claim 1, further comprising:
determining, by the computing system, that the user took the first action when the client device was in a first context;
determining, by the computing system, that the client device was in the first context when the user engaged in the second activity;
wherein causing the client device to present the first user interface element is further based at least in part on the first action having been taken when the client device was in the first context and the client device having been in the first context when the user engaged in the second activity.

5. The method of claim 4, wherein:
determining that the user took the first action when the client device was in the first context further comprises:
determining feature vectors for respective actions the user took with respect to one or more systems of record, the feature vectors representing first context data about one or more client devices at times that respective actions were taken, the feature vectors including a first feature vector for the first action, and
determining, using a predictive model configured to classify input feature vectors into context types, that the first feature vector is classified as a first context type; and
determining that the client device was in the first context when the user engaged in the second activity further comprises:
determining a second feature vector representing second context data about the client device when the user the user engaged in the second activity, and
determining, using the predictive model, that the second feature vector is classified as the first context type.

6. The method of claim 5, further comprising:
generating, using at least a first group of the feature vectors and a clustering process, the predictive model.

7. The method of claim 1, wherein:
the second system of record comprises a first software-as-a-service (SaaS) application;
the first activity comprises operation of a web browser to interact with the first SaaS application;
determining that the first activity is of the first activity type comprises mapping a function performed by the first SaaS application in response to the operation of the web browser to a first microapp that is configured to interact with first SaaS application to perform the function; and
determining that the user has engaged in the second activity of the first activity type comprises determining that the user has interacted with the first microapp.

8. The method of claim 7, wherein:
determining that the user took the first action comprises determining that the user interacted with a second microapp that is configured to interact with the first system of record; and
the first user interface element is selectable to enable the user to access the second microapp to take the second action.

9. The method of claim 1, wherein:
determining that the first activity is of the first activity type comprises determining that the first activity corresponds to a first notification type the computing system is configured to send the user relating to events of the second system of record; and
determining that the user has engaged in the second activity of the first activity type comprises determining that the user has accessed a notification of the first notification type.

10. The method of claim 1, wherein the first system of record is different than the second system of record.

11. The method of claim 1, further comprising:
determining a number of instances in which the user took the first action with respect to the first system of record after engaging in the first activity relating to the second system of record; and
calculating a score based on the number of instances;
wherein causing the client device to present the first user interface element is further based at least in part on the score.

12. A system, comprising:
at least one processor; and
at least one computer-readable medium encoded with instructions which, when executed by the at least one processor, cause the system to:
determine that a user took a first action with respect to a first system of record after engaging in a first activity relating to a second system of record,
determine that the first activity is of a first activity type,
determine that the first action is of a first action type,
determine that the user has engaged in a second activity of the first activity type, and
based at least in part on (A) the user having taken the first action after engaging in the first activity, (B) the first activity being of the first activity type, (C) the first action being of the first action type, and (D) the second activity being of the first activity type, cause a client device to present a first user interface element that is selectable to enable the user to take a second action of the first action type with respect to the second system of record.

13. The system of claim 12, wherein the first activity comprises interaction with a first microapp that is configured to interact with the second system of record, and the at least one computer-readable medium is further encoded with additional instructions which, when executed by the at least one processor, further cause the system to:
determine that the user is engaged in the second activity of the first activity type at least in part by determining that the user has interacted with the first microapp;
determine that the user took the first action at least in part by determining that the user interacted with a second microapp that is configured to interact with the first system of record; and
configure the first user interface element to be selectable to enable the user to access the second microapp to take the second action.

14. The system of claim 12, wherein the first activity comprises interaction with a first microapp that is configured to interact with the second system of record, the first system of record comprises a software-as-a-service (SaaS) application, and the at least one computer-readable medium is further encoded with additional instructions which, when executed by the at least one processor, further cause the system to:
determine that the user is engaged in the second activity of the first activity type at least in part by determining that the user has interacted with the first microapp;
determine that the user took the first action at least in part by determining that the user operated a web browser to interact with the SaaS application to take the first action; and
configure the first user interface element to be selectable to cause the web browser to access the SaaS application to take the second action.

15. The system of claim 12, wherein the at least one computer-readable medium is further encoded with additional instructions which, when executed by the at least one processor, further cause the system to:
determine that the user took the first action when the client device was in a first context;
determine that the client device was in the first context when the user engaged in the second activity; and
cause the client device to present the first user interface element further based at least in part on the first action having been taken when the client device was in the first context and the client device having been in the first context when the user engaged in the second activity.

16. The system of claim 12, wherein the second system of record comprises a first software-as-a-service (SaaS) application, the first activity comprises operation of a web browser to interact with the first SaaS application, and the at least one computer-readable medium is further encoded with additional instructions which, when executed by the at least one processor, further cause the system to:
determine that the first activity is of the first activity type at least in part by mapping a function performed by the first SaaS application in response to the operation of the web browser to a first microapp that is configured to interact with first SaaS application to perform the function; and
determine that the user has engaged in the second activity of the first activity type at least in part by determining that the user has interacted with the first microapp.

17. The system of claim 12, wherein the at least one computer-readable medium is further encoded with additional instructions which, when executed by the at least one processor, further cause the system to:
determine that the first activity is of the first activity type at least in part by determining that the first activity corresponds to a first notification type the system is configured to send the user relating to events of the second system of record; and
determine that the user has engaged in the second activity of the first activity type at least in part by determining that the user has accessed a notification of the first notification type.

18. The system of claim 12, wherein the at least one computer-readable medium is further encoded with additional instructions which, when executed by the at least one processor, further cause the system to:
determine a number of instances in which the user took the first action with respect to the first system of record after engaging in the first activity relating to the second system of record;
calculate a score based on the number of instances; and
cause the client device to present the first user interface element further based at least in part on the score.

19. At least one non-transitory computer-readable medium encoded with instructions which, when executed by at least one processor of a computing system, cause the computing system to:
determine that a user took a first action with respect to a first system of record after engaging in a first activity relating to a second system of record,
determine that the first activity is of a first activity type,
determine that the first action is of a first action type,
determine that the user has engaged in a second activity of the first activity type, and based at least in part on (A) the user having taken the first action after engaging in the first activity, (B) the first activity being of the first activity type, (C) the first action being of the first action type, and (D) the second activity being of the first activity type, cause a client device to present a first user interface element that is selectable to enable the user to take a second action of the first action type with respect to the second system of record.

20. The at least one non-transitory computer-readable medium of claim 19, wherein the first activity comprises interaction with a first microapp that is configured to interact with the second system of record, and the at least one non-transitory computer-readable medium is further encoded with additional instructions which, when executed by the at least one processor, further cause the computing system to:
determine that the user is engaged in the second activity of the first activity type at least in part by determining that the user has interacted with the first microapp;
determine that the user took the first action at least in part by determining that the user interacted with a second microapp that is configured to interact with the first system of record; and
configure the first user interface element to be selectable to enable the user to access the second microapp to take the second action.
